(19) United States
(12) Patent Application Publication
(10) Pub. No.: US 2006/0164563 A1
(43) Pub. Date: Jul. 27, 2006

(54) Digital broadcast receiver

(75) Inventors: Kou Watanabe, Osaka City (JP); Daisuke Hayashi, Neyagawa City (JP); Hisaya Kato, Souraku (JP); Tetsuya Yagi, Katano City (JP)

Correspondence Address: Randolph A Smith;Smith Patent Office, Suite 200, 1901 Pennsylvania Avenue N W, Washington, DC, 20006-3433, US

(73) Assignee: Matsushita Electric Industrial Co., Ltd., Osaka Pref. (JP)

(21) Appl. No.: 10/553,738

(22) PCT Filed: Jun. 15, 2004
(86) PCT No.: PCT/JP04/08704

§ 371 Date: Oct. 20, 2005

(30) Foreign Application Priority Data
Jun. 16, 2003 (JP) 2003-170288
Dec. 15, 2003 (JP) 2003-416299
Apr. 27, 2004 (JP) 2004-131133

(51) Int. Cl. H04N 7/173; H04N 5/50; H04N 5/08; H04N 7/16

(52) U.S. Cl. 348/731; 725/100; 725/131; 725/151; 348/528

(57) ABSTRACT

A tuner has a dual AGC function, and frequency-converts an input signal into an IF signal. An orthogonal detector calculates a complex signal from the IF signal. A demodulator demodulates a digital signal from the complex signals. An error corrector corrects the error of the digital signal. A signal level detector calculates a level judgment signal from the IF signal. A demodulation level detector detects a signal level of a demodulation signal on a desired band from an output signal of the demodulator. When a demodulation level judgment unit generates a judgment signal representing an influence from interference waves in adjacent channel affecting on a signal on the desired band from the demodulation signal, a control signal generator feeds back a gain control signal to the tuner in accordance with the judgment signal.

### TECHNICAL FIELD

The present invention relates to a digital broadcasting receiver centered around an automatic gain controller capable of controlling an influence resulting from adjacent interferences caused by signals in adjacent channel with respect to digital broadcast waves and including a technology for improving a reception characteristic of the digital broadcast waves.

### BACKGROUND ART

Digitalization of communication technology in recent years has been developed into the field of broadcasting. Digital television digital audio broadcasting services have put into practical use. In Japan, the broadcasting services via broadcast satellites have become available, and various experiments on terrestrial broadcasting toward commercialization have been completed and new broadcasting services have been launched.

Terrestrial digital broadcast waves and analogue broadcast waves will be transmitted simultaneously for some time after the start of its services. In simultaneous broadcasts, wherein the digital and analogue broadcast waves coexist, when the analogue broadcast waves are present in a adjacent channel of the channel of the digital broadcast waves, the digital broadcast waves can be interference waves with respect to the analogue broadcast waves. In order to prevent such problems, the current digital broadcast waves are transmitted with smaller signal levels than the analogue broadcast waves.

In the abovementioned situation, wherein the digital and analogue broadcast waves coexist, JP-A 2000-312235 discloses a conventional technology for reducing interferences of the analogue and digital waves.

FIG. 1 shows a configuration of a conventional digital broadcast receiver with an automatic gain controller as its main block. The digital broadcast receiver comprises a tuner 101, an orthogonal detector (O.D.) 102, a demodulator (DEM.) 103, an error corrector (ERR.C.) 104, an error detection/judgment unit 114, a signal (SG.) level detector 105, and a control signal (C.SG.) generator 106.

The foregoing automatic gain controller constitutes a circuitry where an automatic gain control signal is generated on the basis of an output signal of the tuner 101 and an error correction result of the error corrector 104 and is fed back to the tuner 101. The automatic gain controller according to the conventional technology is constituted by the error detection/judgment unit 114, the signal level detector 105, and the control signal generator 106.

FIG. 2 shows a configuration of the tuner 101. The tuner 101 has a dual AGC function, signal processings of which will be described below.

A band path filter (hereafter, referred to as BPF) 201 limits the band of an input signal and outputs the signal to a RF-AGC amplifier 202. The RF-AGC amplifier 202 controls the gain of the output signal from the BPF 201 by means of a gain control signal (hereinafter, referred to as RF-AGC control signal) c1 on a RF band from the control signal generator 106. Further, the BPF 203 limits the band of the output of the RF-AGC amplifier 202. Thereafter, a first frequency converter 204 converts the frequency of the output of the BPF 203 into an intermediate frequency on the basis of a channel selection signal c3. A SAW filter (SAW) 205 limits the band of the output of the first frequency converter 204, and then outputs (signals) to a first intermediate frequency (IF) amplifier 206. The first IF amplifier 206 amplifies a signal from SAW 205 and, subsequently, outputs the signal to a SAW filter 209. The SAW filter 209 limits the band of the output of the first IF amplifier 206 and, then, outputs the signal to an IF-AGC amplifier 210.

The IF-AGC amplifier 210 controls the gain of the output signal of the SAW filter 209 on the basis of a gain control signal (hereinafter, referred to as IF-AGC control signal) c2 on an IF band from the control signal generator 106, and outputs the gain-controlled signal to a second frequency converter 211. The second frequency converter 211 converts the frequency of the signal controlled in the IF-AGC amplifier 210 into an IF frequency. A second IF amplifier 212 adjusts a level of the signal converted into the IF frequency, and outputs the level-adjusted signal to the orthogonal detector 102 of FIG. 1 as the output signal of the tuner 101.

The orthogonal detector 102 implements an orthogonal detection to a digital-modulated digital signal such as OFDM (Orthogonal Frequency Division Multiplex) and outputs I and Q signals, which are complex signals, to the demodulator 103. The demodulator 103 demodulates the digital signal from the I and Q signals and outputs the demodulated signal to the error corrector 104.

The error corrector 104 implements an error correction processing to the digital signal, and outputs the corrected digital signal to the error rate detection/judgment unit 114 and a data processor (not shown). The error rate detection/judgment unit 114 detects an error rate of the error-corrected digital signal, and outputs optimum delay point information in accordance with the error rate to the control signal generator 106.

The signal level detector 105 detects a signal level of an IF signal d1 outputted from the tuner 101, and outputs the detected signal level to the control signal generator 106 as a level judgment signal a1. The control signal generator 106 calculates gain control signals c1 and c2 on the basis of the level judgment signal a1 supplied from the signal level detector 105, and feeds back the gain control signals c1 and c2 to the tuner 101.

FIG. 3 shows a configuration of the signal level detector 105. The signal level detector 105 is constituted by a level calculation block 105a, an offset calculation block 105b, and a loop filter 105c. The level calculation block 105a calculates the level of the IF signal d1 outputted from the tuner 101, and outputs the calculation result to the offset calculation block 105b as power information pw. The offset calculation block 105b calculates a difference between the power information pw outputted from the level calculation block 105a and a desired level, and outputs the calculation result to the loop filter 105c as offset information. The loop filter 105c integrates the offset information outputted from the offset calculation block 105b to generate the level judgment signal a1, and outputs the level judgment signal a1 to the control signal generator 106 of FIG. 1.

Next, description of an operation of the automatic gain controller and a function of a delay point will be given. The automatic gain controller implements the gain control in two systems of RF and IF stages in response to field strengths of the inputted broadcast waves so that the signal levels of the demodulated signals can be constant. The delay point is a switching point where a value of the RF-AGC control signal c1 and a value of the IF-AGC control signal c2 are varied in accordance with a demodulation state. The function of the delay point will be described in detail later.

In general, the automatic gain control with respect to a signal level of an input signal is implemented by means of the automatic gain control on the RF band (hereinafter, referred to as RF-AGC) or the automatic gain control on the IF band (hereinafter, referred to as IF-AGC). The delay point value dp serves to determine which of those two is made variable.

FIG. 4 is a view for describing a gain control characteristic of the control signal generator 106. An abscissa therein represents a size of the level judgment signal a1, and an ordinate represents a gain g of the AGC amplifier. FIG. 4A shows a method of a gain controlling of the AGC amplifier in the absence of the adjacent channels. FIG. 4B shows a method of a gain controlling of the AGC amplifier in the presence of the adjacent channels.

When the level judgment signal a1 supplied from the signal level detector 105 is small, the RF-AGC control signal c1, which is an output signal of the control signal generator 106, to be provided for the RF-AGC amplifier 202 is maintained a big constant value. It is more advantageous in terms of NF (Noise Figure) that the gain is controlled by means of the IF-AGC control signal c2, which is another output signal of the control signal generator 106, to be provided for the IF-AGC amplifier 210, as described.

However, as shown in FIG. 4B, when the input signal includes any interference wave in adjacent channel and the RF-AGC control signal c1 is large, the signal can be possibly distorted in the RF-AGC amplifier 202, thereby presenting a nonlinear amplification characteristic shown in FIG. 5. When a signal processing is implemented in the nonlinear region, a waveform of a demodulated signal on a frequency axis includes noise components on n adjacent channel of a desired channel Bi, as shown in FIG. 6. The NF and the signal distortion are in a trade-off relationship. A delay point variation signal Δdp (hereinafter, referred to as step signal) is a numeric value for increasing or decreasing the delay point value dp. Whether increased or decreased, it is necessary to set a border where the NF and the signal distortion have a favorable relationship as the delay point.

As shown in FIG. 4A, the control signal generator 106, in the absence of the interference waves in adjacent channels, maintains the gain of the RF-AGC amplifier 202 at a predetermined value g1 with respect to the level judgment signal a1 smaller than a first threshold value Wth1, and decreases the gain of the RF-AGC amplifier 202 with respect to the level judgment signal a1 larger than the first threshold value Wth1 as the level judgment signal a1 becomes larger.

As shown in FIG. 4B, the control signal generator 106, in the presence of the interference waves in adjacent channels, maintains the gain of the RF-AGC amplifier 202 at a predetermined value g2 with respect to the level judgment signal a1 smaller than a second threshold value Wth2, and decreases the gain of the RF-AGC amplifier 202 with respect to the level judgment signal a1 larger than the second threshold value Wth2 as the level judgment signal a1 becomes larger. The second threshold value Wth2 is preferably set to be smaller than the first threshold value Wth1 to thereby control the distortion of the signal in the RF-AGC amplifier 202.

In the case of the gain control characteristic, where the delay point value is fixed, when the delay point is set on the basis of the judgment that the waves in adjacent channels do not exist, a distortion is generated in the RF-AGC amplifier 202 in the presence of any interference wave having a high signal level on the adjacent channels. When the delay point is set on the basis of the judgment that the waves in adjacent channel exist, a reception characteristic always results in the poor NF in the absence of the interference waves on the adjacent channels. Conventionally, the error rate denoting the deterioration of the reception state has been monitored at the latter part of DEM 103, and the delay point has been changed so that the gain control characteristics with few errors are achieved on the basis of the error rate information.

In the digital broadcast receiver according to the configuration of FIG. 1, however, the error rate is detected after the error correction and, further, there is the problem in that the instruction of the delay point change given to the automatic gain controller is significantly late in the case of accompanying a deinterleaving processing.

Further, it is necessary to implement the error correction processing of the hierarchically transmitted signals for each hierarchy, and it is accordingly necessary to implement the error rate detection for each hierarchy. It is further necessary to determine which error rate should be selected from the different hierarchies for the instruction of the delay point change.

Therefore, the present invention is made in order to solve the foregoing problems. A main object of the present invention is to realize the digital broadcast receiver having functions of detecting the high interference waves in adjacent channels prior to the implementation of the error correction processing, suppressing the deterioration of the reception characteristic irrespective of the transmission with or without hierarchy, and automatically changing the delay point in order to achieve a favorable reception state.

### DISCLOSURE OF INVENTION

A digital broadcast receiver according to the present invention comprises a tuner which amplifies an input signal to select a RF signal on a desired band and amplifies the RF signal to frequency-convert the RF signal into an IF signal. An orthogonal detector calculates I and Q complex signals on the basis of the IF signal of the tuner. A demodulator demodulates a digital signal from the I and Q complex signals of the orthogonal detector. In the process, a signal level detector in an automatic gain controller detects a signal level of a reception signal from the IF signal of the tuner. A demodulation level detector detects a demodulation level of a demodulation signal on the desired channel on the basis of the demodulation output of the demodulator. Next, a demodulation level judgment unit generates a demodulation level judgment signal showing any influence from interference waves in adjacent channel affecting on the demodulation signal on the desired channel from the demodulation level signal of the demodulation level detector. A control signal generator generates a gain control signal on a RF band and a gain control signal on an IF band in accordance with the demodulation level judgment signal, and feeds back the both gain control signals to the tuner.

Further, the digital broadcast receiver according to the present invention comprises a tuner, an orthogonal detector, and a demodulator, in the same manner as in the above mentioned digital broadcast receiver. A state monitor in the automatic gain controller detects a demodulation state from the demodulation output from the demodulator and generates a demodulation state signal. A retainer retains the demodulation state signal outputted from the state monitor for a certain period of time. A comparator compares the demodulation state signal outputted from the state monitor and the demodulation state signal retained by the retainer to output a comparison signal representing a transition of the demodulation state after a certain period of time. A switch unit determines a variation of a delay point on the basis of the comparison signal from the comparator and the demodulation state signal obtained from the state monitor when a point of switching between the gain control signal on the RF-band and the gain control signal on the IF-band in the tuner is set to be the delay point. A delay point determination unit renews a delay point value in accordance with the variation of the delay point determined by the switch unit. In the meantime, the signal level detector detects the signal level of the reception signal from the IF signal of the tuner. The control signal generator generates the gain control signal on the RF-band and the gain control signal on the IF-band using the delay point value of the delay point determination unit and the signal level of the signal level detector, and outputs the generated gain control signals to the tuner.

According to the present invention as described above, the high interference waves in adjacent channels can be detected prior to the implementation of the error correction processing, the deterioration of the reception characteristic is suppressed irrespective of transmission with or without hierarchy, and the delay point can be automatically changed to achieve a favorable reception state. Accordingly, a channel-selection function in the tuner having a dual AGC function can be further improved in any environment, where simultaneous broadcasts are transmitted. Moreover, the channel-selection function in the tuner can be further improved in the presence a large number of neighboring digital broadcast channels.

### BRIEF DESCRIPTION OF DRAWINGS

FIG. 1 is a view illustrating a configuration of a conventional digital broadcast receiver.

FIG. 2 is a block diagram illustrating an internal configuration of a tuner in respective embodiments.

FIG. 3 is a block diagram illustrating an internal configuration of a signal level detector.

FIGS. 4A and 4B are explanatory views showing distribution methods of a gain in a control signal generator.

FIG. 5 is a view showing an input/output characteristic of a RF-AGC amplifier.

FIG. 6 is a view showing a frequency characteristic of an FFT output.

FIG. 7 is a view illustrating a configuration of a digital broadcast receiver according to Embodiment 1 of the present invention.

FIG. 8 is a block diagram illustrating an internal configuration of a demodulation level detector.

FIGS. 9A and 9B are explanatory views showing influences of a NTSC signal in adjacent channels on an OFDM signal.

FIG. 10 is a view illustrating a configuration of a digital broadcast receiver according to Embodiment 2 of the present invention.

FIG. 11 is a view illustrating a configuration of a signal level judgment block according to Embodiment 2.

FIG. 12 is a view illustrating a configuration of a digital broadcast receiver according to Embodiment 3 of the present invention.

FIG. 13 is a view illustrating a configuration of a tuner according to Embodiment 3 of the present invention.

FIG. 14 is a view illustrating a configuration of a digital broadcast receiver according to Embodiment 4 of the present invention.

FIG. 15 is a block diagram illustrating an interval configuration of a C/N detector according to Embodiment 4.

FIG. 16 is a view illustrating a configuration of a digital broadcast receiver according to Embodiment 5 of the present invention.

FIG. 17 is a view illustrating an internal configuration of a switch unit used in the digital broadcast receiver according to Embodiment 5.

FIG. 18 is a characteristic view showing a relationship between a demodulation state and delay point in a digital broadcast receiver.

FIG. 19 is a view illustrating a configuration of a digital broadcast receiver according to Embodiment 6 of the present invention.

FIG. 20 is a view illustrating an internal configuration of a switch unit used in the digital broadcast receiver according to Embodiment 6.

FIG. 21 is an explanatory view showing a correspondence among a demodulation state signal, delay point, and step signal in the digital broadcast receiver according to Embodiment 6.

FIG. 22 is a view illustrating a configuration of a digital broadcast receiver according to Embodiment 7 of the present invention.

FIG. 23 is a state diagram showing a temporal transition of a demodulation state signal and delay point in the digital broadcast receiver according to Embodiment 7.

FIG. 24 is a view illustrating a configuration of a digital broadcast receiver according to Embodiment 8 of the present invention.

FIG. 25 is a view illustrating a configuration of a digital broadcast receiver according to Embodiment 9 of the present invention.

FIG. 26 is a view illustrating an internal configuration of a switch unit used in the digital broadcast receiver according to Embodiment 9.

FIG. 27 is a state diagram showing operation conditions of the switch unit according to Embodiment 9.

FIG. 28 is a view illustrating a configuration of a digital broadcast receiver according to Embodiment 10 of the present invention.

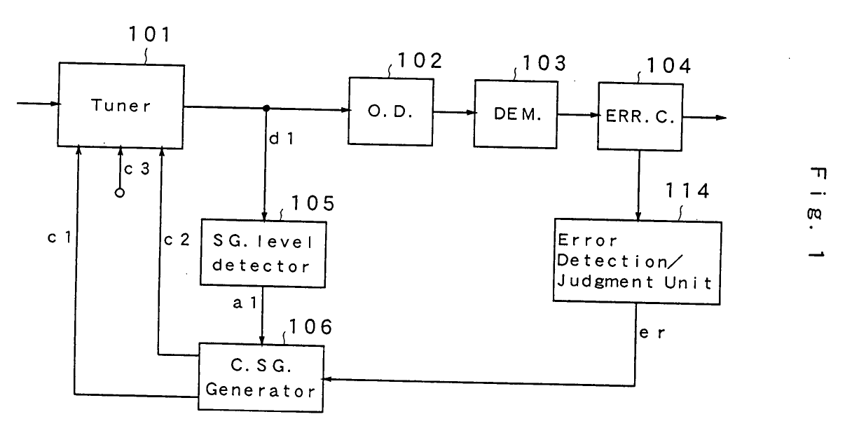

### BEST MODE FOR CARRYING OUT THE INVENTION

### Embodiment 1

A digital broadcast receiver according to Embodiment 1 of the present invention will be described referring to FIG. 7. FIG. 7 is a view illustrating a configuration of the digital broadcast receiver centered around an automatic gain controller according to Embodiment 1.

The digital broadcast receiver shown in FIG. 7 comprises an automatic gain controller 10A, a tuner 101, an orthogonal detector 102, a demodulator 103, and an error corrector 104. The tuner 101 amplifies an input signal to select a RF signal on a desired band and amplifies the RF signal to frequency-converts the RF signal into an IF signal. The orthogonal detector 102 calculates I and Q complex signals from the IF signal of the tuner 101. The demodulator 103 is constituted by an FFT block 103a and an equalizer (EQ) 103b and demodulates a digital signal from the I and Q complex signals of the orthogonal detector 102.

The automatic gain controller 100A detects a signal level of a reception signal from the IF signal of the tuner 101 and, also, the demodulator 103 detects a demodulation state. The automatic gain controller 100A further judges a level of an influence from interference waves in adjacent channels affecting on a demodulation signal on the desired band to thereby generate a gain control signal on a RF band and a gain control signal on an IF band in accordance with the level of the influence from interference waves in adjacent channels and the reception signal level, and feeds back the both gain control signals to the tuner 101.

The automatic gain controller 100A according to Embodiment 1 includes a signal level detector 105, a control signal generator 106, a demodulation level detector 107, and a demodulation level judgment unit 108.

The signal level detector 105 detects the signal level of the reception signal from the IF signal of the tuner 101. The demodulation level detector 107 detects a demodulation level of the demodulation signal on the desired band from the output of the demodulator 103. The judgment unit 108 generates a demodulation level judgment signal representing the influence level from the interference waves in adjacent channels affecting on the demodulation signal on the desired band from the demodulation level of the demodulation level detector 107. The control signal generator 106 generates the gain control signal on the RF-band and the gain control signal on the IF-band in accordance with the demodulation level judgment signal of the judgment unit 108 and the signal level of the signal level detector 105, and feeds back the both gain control signals to the tuner 101.

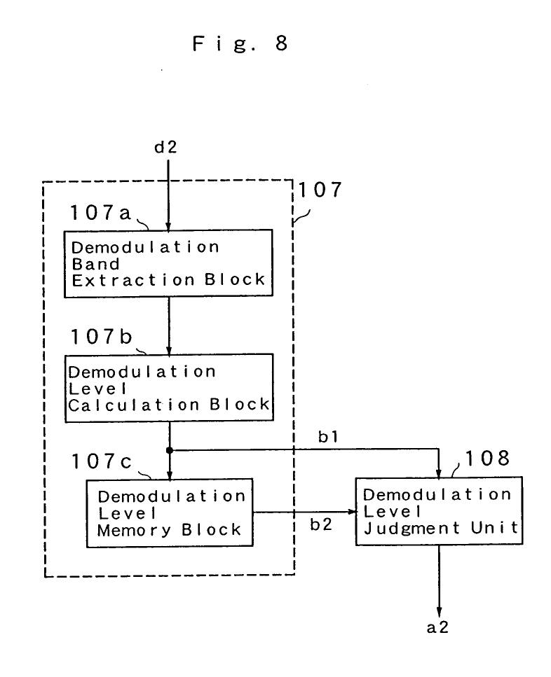

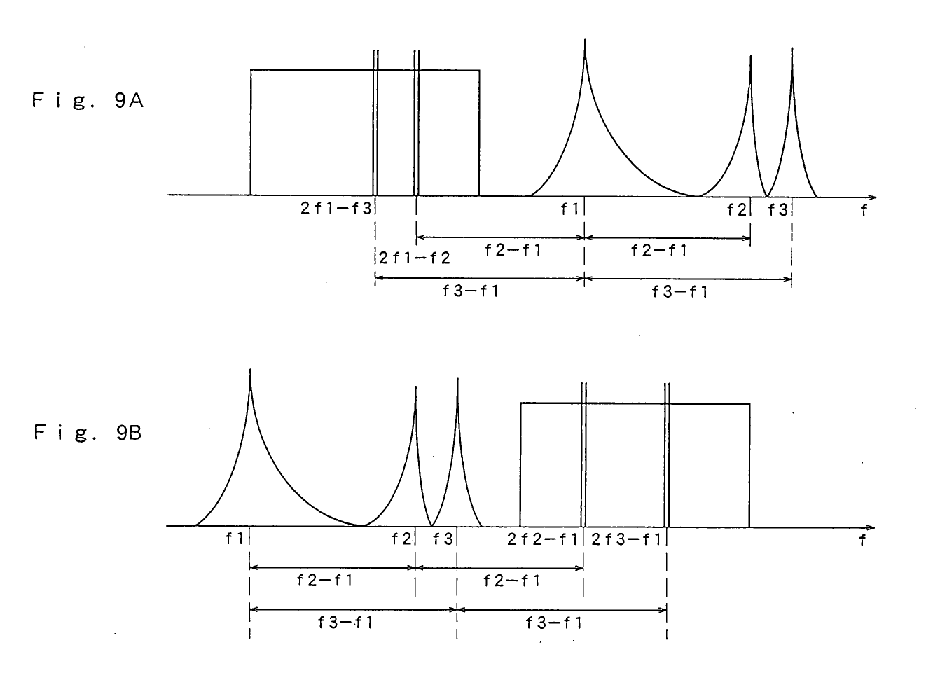

The components of the automatic gain controller 100A will now be described in detail. The demodulation level detector 107, as shown in FIG. 8, is constituted by a demodulation band extraction block 107a, a demodulation level calculation block 107b, and a demodulation level memory block 107c. The extraction block 107a extracts the desired-band signal when an output signal of the FFT block 103a of FIG. 7 is given thereto, and outputs the extraction output to the calculation block 107b. The calculation block 107b calculates a level of the signal supplied from the extraction block 107a, and outputs the calculation output to the memory block 107c and demodulation level judgment unit 108. The memory block 107c stores a demodulation level signal b1 supplied from the calculation block 107b, and outputs the stored output to the judgment unit 108. The demodulation level judgment unit 108, in response to the supply of the demodulation level signal b1 from the calculation block 107b and a demodulation level signal b2 stored in the memory block 107c, generates a demodulation level judgment signal a2, and outputs the signal a2 to the control signal generator 106.

A delay point control according to Embodiment 1 will be described referring to FIGS. 7 and 8. When the interference waves in adjacent channels exist in a certain reception environment, an IF signal d1 supplied to the orthogonal detector 102 from the tuner 101 constitutes the desired-channel signal with signals on adjacent channels added thereto. The IF signal d1 including both the desired-channel signal and the adjacent channel are therein is subject to an orthogonal detection processing and an FFT processing without any separation process. The signal level after the gain control is controlled to constantly stay at a preset signal level. Because of that, when the interference waves in adjacent channels exist, a value shown by the desired-channel signal level is reduced by an equivalence of the interference waves in adjacent channels. Therefore, the level of the influence from the interference waves in adjacent channels affecting on the desired channel can be judged by looking into a transition of the demodulated signal level on the desired channel.

The demodulation level detector 107 extracts the desired-channel signal on a frequency axis from an FFT output signal d2 of the FFT block 103a, and stores the level of the extracted signal in the demodulation level memory block 107c, in the state of which the delay point is changed. When the delay point changes, the RF-AGC control signal c1 accordingly changes though the level judgment signal a1 is the same value; therefore, an input/output characteristic of the RF-AGC amplifier 202 changes. The change of the input/output characteristic serves to change a range of an input level, at which an output of the RF-AGC amplifier 202 is saturated; therefore, the desired-channel signal level calculated in the calculation block 107b also changes. The signal levels on the desired channel before and after the change of the delay point (demodulation level signal) are compared. To be more specific, the demodulation level signal b2 before the delay point change outputted from the memory block 107c and the demodulation level signal b1 after the delay point change outputted from the calculation block 107b are compared in the demodulation level judgment unit 108. When the level signal b1 calculated after the delay point change is larger than the level signal b2 stored before the delay point change, it is indicated that signal processings are reduced in a region, where the output of the RF-AGC amplifier 202 is saturated, because of the change of the delay point.

On the contrary, when the level signal b1 calculated after the change of the delay point is smaller than the level signal b2 prior to the change of the delay point, it is indicated that the signal processings are increased in the region, where the output of the RF-AGC amplifier 202 is saturated, because of the change of the delay point. Therefore, the delay point should be changed so as to reduce the signal processings in the region where the output of the RF-AGC amplifier 202 is saturated.

When no signal processing is executed in the region where the output of the RF-AGC amplifier 202 is saturated, that is, when there is no difference between the demodulation level signal b1 and the stored demodulation level signal b2, it is interpreted that there is no interference wave in adjacent channels, in the case of which it is unnecessary to change the delay point.

It is unnecessary to continually renew the delay point. The average values calculated by averaging the signal levels of the demodulation level signal b1 at certain periodical intervals can be used to compare the signal levels.

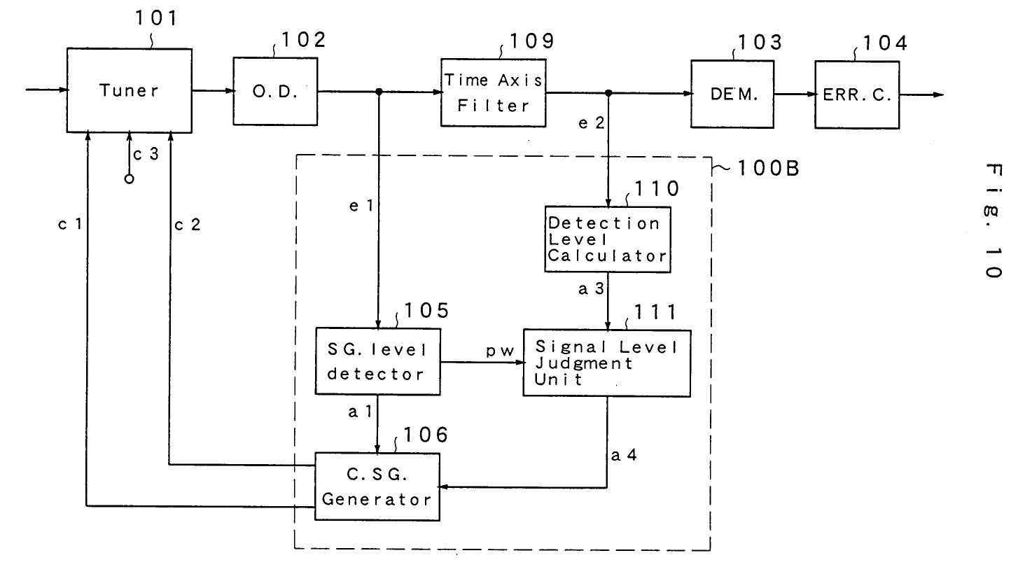

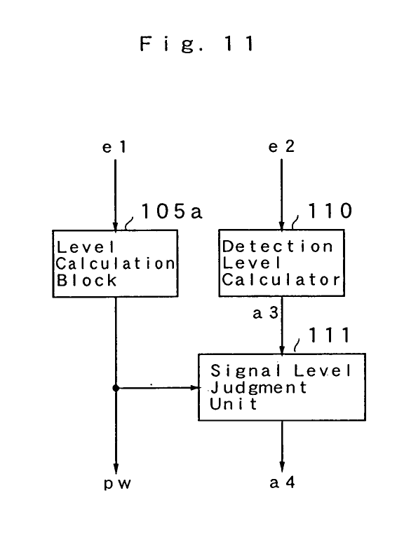

If the interference wave in adjacent channels is an NTC analogue signal, a third-order distortion component appears on a particular frequency in the desired channel when the output of the RF-AGC amplifier 202 is saturated. More specifically, as shown in FIG. 9A, when the NTSC signal in adjacent channels has higher frequency then a desired OFDM signal, the third-order distortion components of 2f1-f2 and 2f1-f3 emerge, where video carrier frequency of the NTSC f1, color sub-carrier is f2 and an audio carrier is f3. In the same manner, as shown in FIG. 9B, when the NTSC signal in adjacent channels has lower frequency than the desired OFDM signal, the third-order distortion components of 2f2-f1 and 2f3-f1 emerge.

The signal extracted by the demodulation band extraction block 107a is limited to the particular frequency on which the third-order distortion component due to the NTSC signal emerges, and the signal of the particular frequency alone is level-calculated in the demodulation level calculation block 107b to thereby reduce a circuit scale. The signal extracted in the extraction block 107a can have a certain range of frequency centered around the particular frequency, on which the third-order distortion due to the NTSC signal emerges, so as to flexibly respond to any frequency lag. The case of the signal in adjacent channels being the NTSC signal will be described as an example; however, the foregoing method is applicable to any signal other than the NTSC signal.

In the foregoing example, the automatic gain controller 100A executes the signal processings in the region where the output of the RF-AGC amplifier 202 is saturated based on the signal level on the desired channel calculated in the demodulation level detector 107. However, the configuration may be that a signal informing of the execution of the signal processings in the region, where the output of the RF-AGC amplifier 202 is saturated, is outputted to the control signal generator 106 and the change of the delay point is commenced so that the signal processings are reduced in the region, where the output of the RF-AGC amplifier 202 is saturated, in response to the signal.

Further, in the foregoing example, the level judgment signal a1 to be inputted to the control signal generator 106 is calculated from the IF signal d1 of the tuner 101. However, the level judgment signal a1 can be calculated from a base band signal from the orthogonal detector 102 onward.

### Embodiment 2

Next, description will be given of a digital broadcast receiver according to Embodiment 2 of the present invention referring to FIG. 10. FIG. 10 is a view illustrating a configuration of the digital broadcast receiver centered around an automatic gain controller according to Embodiment 2.

The digital broadcast receiver according to Embodiment 2 further comprises, in the digital broadcast receiver shown in FIG. 7, a time axis filter 109 between the orthogonal detector 102 and demodulator 103, and an automatic gain controller 100B, which is different from the automatic gain controller 100A.

The automatic gain controller 100B includes the signal level detector 105, control signal generator 106, a detection level calculator 110, and a signal level judgment unit 111.

The time axis filter 109 is constituted by a digital filter. The time axis filter 109, when an output signal of the orthogonal detector 102 is supplied thereto, extracts a signal component on the desired channel and outputs a signal e2 to the demodulator 103 and detection level calculator 110.

The signal level detector 105, when the output signal, from which an imaging component resulting from sampling is removed, is supplied thereto from the orthogonal detector 102, generates the level judgment signal a1 and outputs the signal a1 to the control signal generator 106. The detection level calculator 110 calculates the level of the signal e2 supplied from the time axis filter 109, and outputs the calculation result to the judgment unit 111 as a detection level signal a3. The judgment unit 111 receives the detection level signal a3 from the detection level calculator 110. The judgment unit 111, when receiving the detection level signal a3 from the detection level calculator 110 and power information pw prior to the removal of the sampling-caused imaging component from a level calculation block 105a of the signal level detector 105, outputs a signal level judgment signal a4 to the control signal generator 106.

A delay point control according to Embodiment 2 will be described referring to FIGS. 10 and 11. When the interference waves in adjacent channels exist in a certain reception environment, the signal on a desired channel provided with the signals outside the desired channel are outputted to the tuner 101. In the foregoing process, the time axis filter 109 extracts only the signal e2 on the desired channel. The signal level judgment unit 111 compares the detection level signal a3, which is the level of the extracted signal e2, and the power information pw calculated in the level calculation block 105a. When the detection level signal a3 is smaller than the power information pw in terms of the signal level, the presence of the interference waves in adjacent channel is indicated. The control signal generator 106 therefore changes the delay point.

When the level judgment signal a1 is the same value, the RF-AGC control signal c1 fed back to the RF-AGC amplifier 202 from the control signal generator 106 changes due to the changed delay point. This accordingly increases or decreases the signal processings executed in the region where the output of the RF-AGC amplifier 202 is saturated. The delay point should be changed in such manner that the signal processings in the foregoing region are decreased.

When no signal processing is executed in the region where the output of the RF-AGC amplifier 202 is saturated, that is, when there is no difference between the detection level signal a3 and the power information pw, it is regarded that that the interference waves in adjacent channels do not exist. In this case, the control signal generator 106 does not change the delay point.

It is unnecessary to continually renew the delay point through the comparison of the signal levels in the signal level judgment unit 111. The detection level signal a3 and power information pw can be averaged at certain periodical intervals so that the average values are used to compare the signal levels.

In the present embodiment, the signal levels calculated in the level calculation block 105a and detection level calculator 110 are compared to thereby detect whether or not the signal processings are executed in the region where the output of the RF-AGC amplifier 202 is saturated. Alternatively, a signal directly informing of the executed signal processings in the region, where the output of the RF-AGC amplifier 202 is saturated, can be outputted from the tuner 101 to the control signal generator 106 to thereby start the delay point change in such manner that the signal processings are reduced in the region, where the output of the RF-AGC amplifier 202 is saturated, in response to the signal.

### Embodiment 3

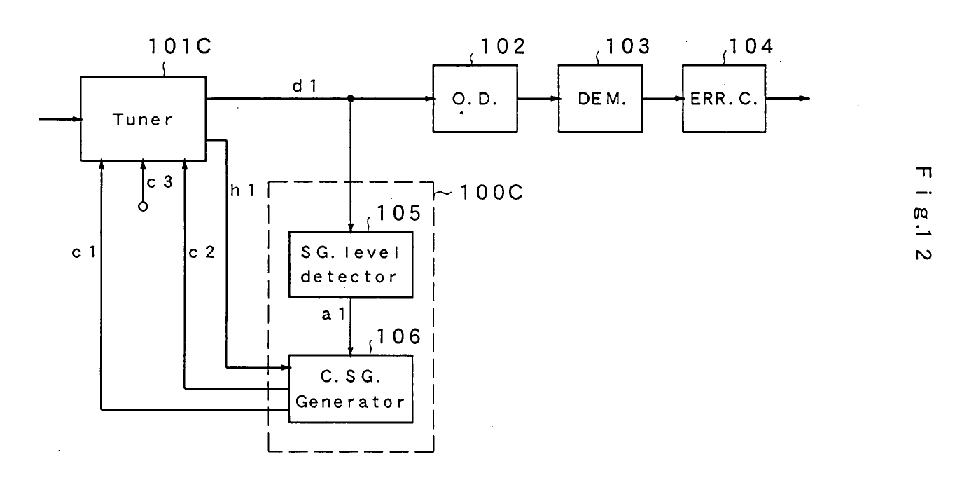

Next, description will be given of a digital broadcast receiver according to Embodiment 3 of the present invention referring to FIG. 12. FIG. 12 is a view illustrating a configuration of the digital broadcast receiver centered around an automatic gain controller according to Embodiment 3.

The digital broadcast receiver according to the present embodiment comprises a tuner 101C and an automatic gain controller 100C each having a configuration different from those according to Embodiments 1 and 2, in addition to the orthogonal detector 102, demodulator 103, and error corrector 104 in the same manner as in Embodiment 1. The automatic gain controller 100C includes the signal level detector 105 and control signal generator 106. In the present embodiment, the tuner 101C detects the presence of the interference waves in adjacent channels and outputs a adjacent judgment signal h1 to the control signal generator 106 and thereby controls the delay point.

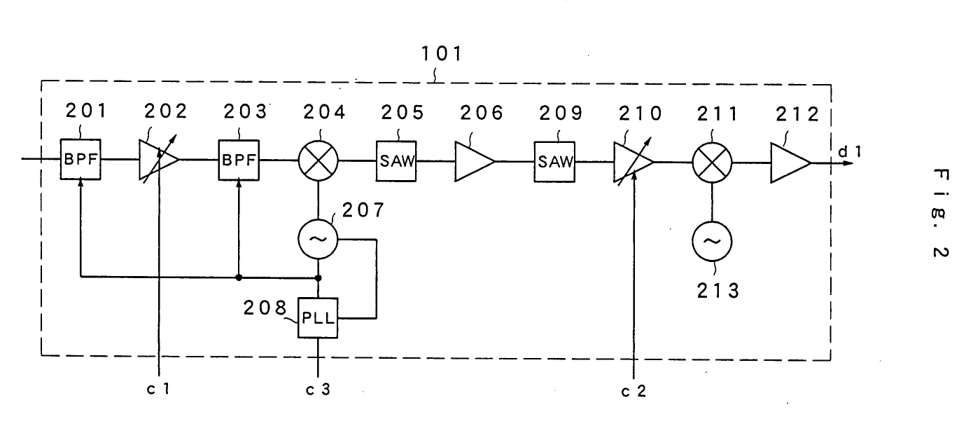

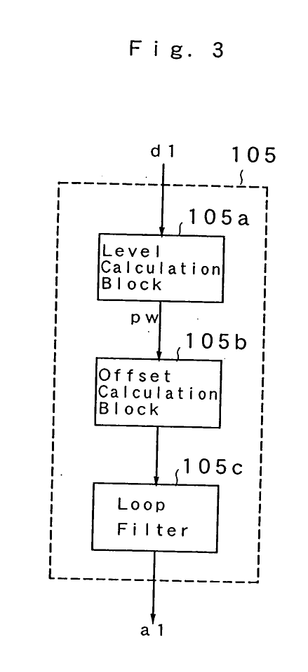

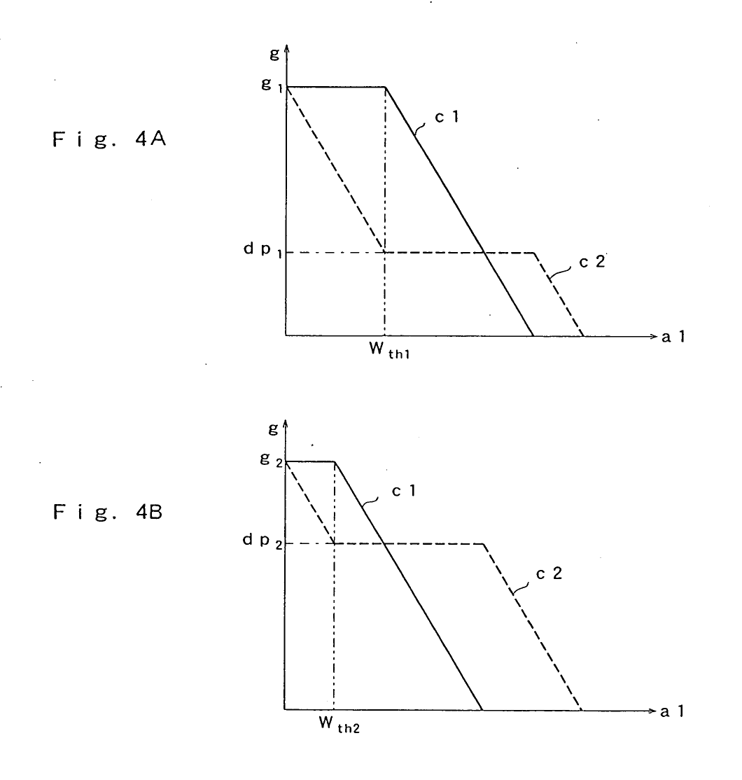

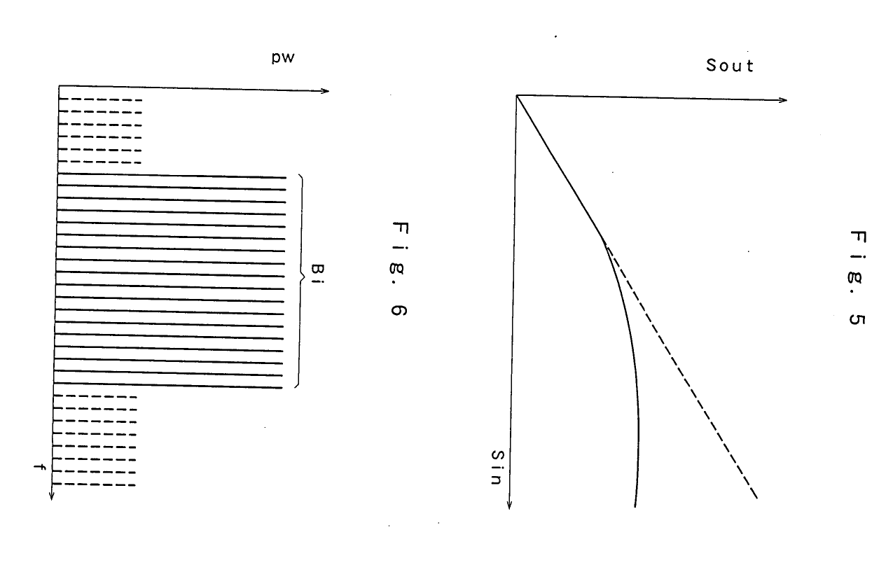

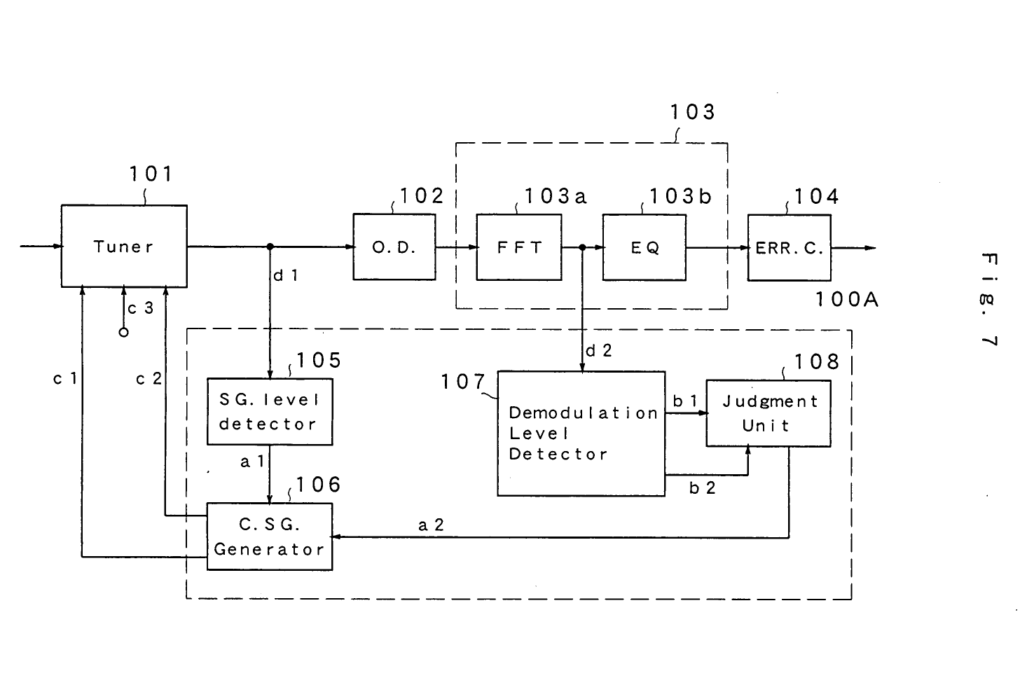

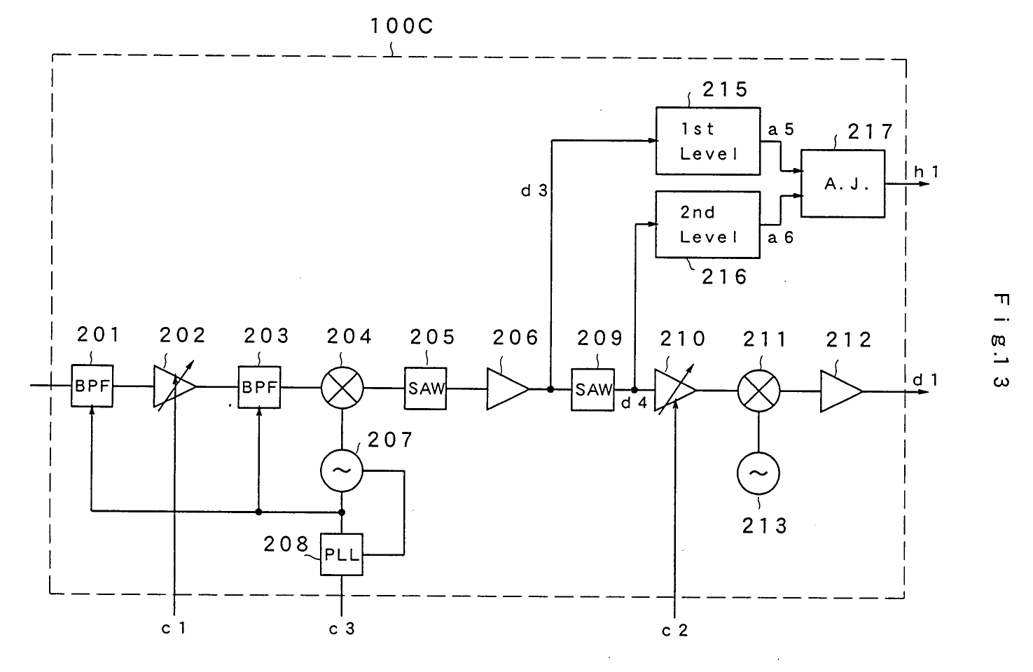

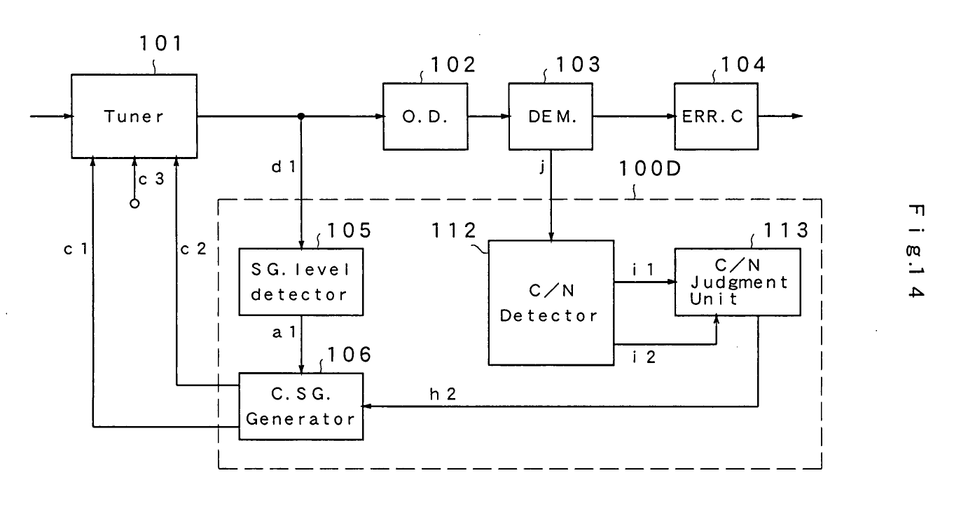

A delay point control according to Embodiment 3 will be described referring to FIGS. 12 and 13. As shown in FIG. 13, the tuner 101C is the tuner of FIG. 2 further provided with a first level detection block 215, a second level detection block 216, and an adjacent judgment (A.J.) block 217. The first level detection block 215 inputs a first intermediate frequency (IF) signal d3 therein, detects a signal level thereof, and outputs a first intermediate frequency signal level a5 to the adjacent judgment block 217. The second level detection block 216 inputs a second IF signal d4 therein, detects a signal level thereof, and outputs a second IF signal level a6 to the adjacent judgment block 217. The adjacent judgment block 217 judges the interference level caused by the interference waves in adjacent channels from the first IF signal level a5 and the second IF signal level a6, and outputs the adjacent judgment signal h1 to the control signal generator 106.

In the presence of the interference waves in adjacent channels, an input signal of a SAW filter 209 of the tuner 101 includes the signals outside the desired channel therein; however, any component outside the desired channel is removed from an output signal of the SAW filter 209. The signal levels of input and output signals of the SAW filter 209 are compared so that the presence of the interference waves in adjacent channel is detected and the delay point is accordingly changed.

When the delay point is changed in the case of the level judgment signal a1 being the same value, the RF-AGC control signal c1 fed back to the RF-AGC amplifier 202 changes. In this case, the signal processings in the region, where the output of the RF-AGC amplifier 202 is saturated, increases or decreases. Therefore, the delay point should be changed so that the signal processings in the region are reduced.

When no signal processing is implemented in the region where the output of the RF-AGC amplifier 202 is saturated, that is, when there is no difference between the first IF signal level a5 and the second IF signal level a6, it is regarded that there is no interference wave in adjacent channel, and the delay point is therefore not changed.

It is unnecessary to continually renew the delay point through the comparison of the signal levels in the adjacent judgment block 217. Alternatively, the signal levels of the first IF signal d3 and the second IF signal d4 are averaged at certain periodical intervals, and the average values can be used to compare the signal levels.

Further, in the present embodiment, the level judgment signal a1 to be inputted to the control signal generator 106 is calculated from the IF signal d1 of the tuner 101. The level judgment signal a1, however, can be calculated from the base band signal from the orthogonal detector 102.

### Embodiment 4

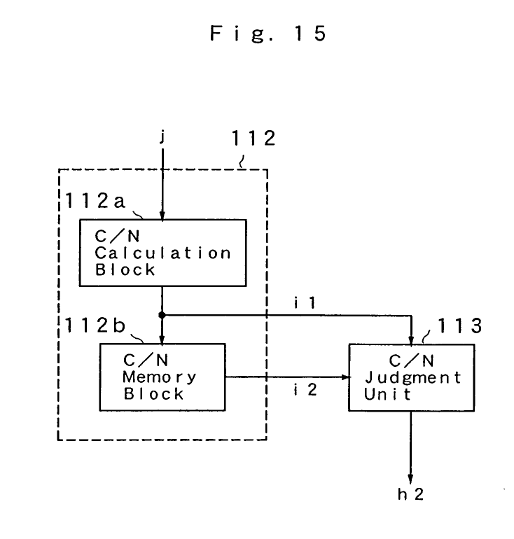

A digital broadcast receiver according to Embodiment 4 of the present invention will now be described referring to FIG. 14. FIG. 14 is a view illustrating a configuration of the digital broadcast receiver centered around an automatic gain controller according to Embodiment 4 of the present invention.

The digital broadcast receiver according to the present embodiment comprises, in addition to the tuner 101, orthogonal detector 102, demodulator 103, and error corrector 104 as in Embodiment 1, an automatic gain controller 100D having a configuration different from the configurations according to Embodiments 1 through 3. The automatic gain controller 100D includes the signal level detector 105, control signal generator 106, a C/N detector 112, and a C/N judgment unit 113.

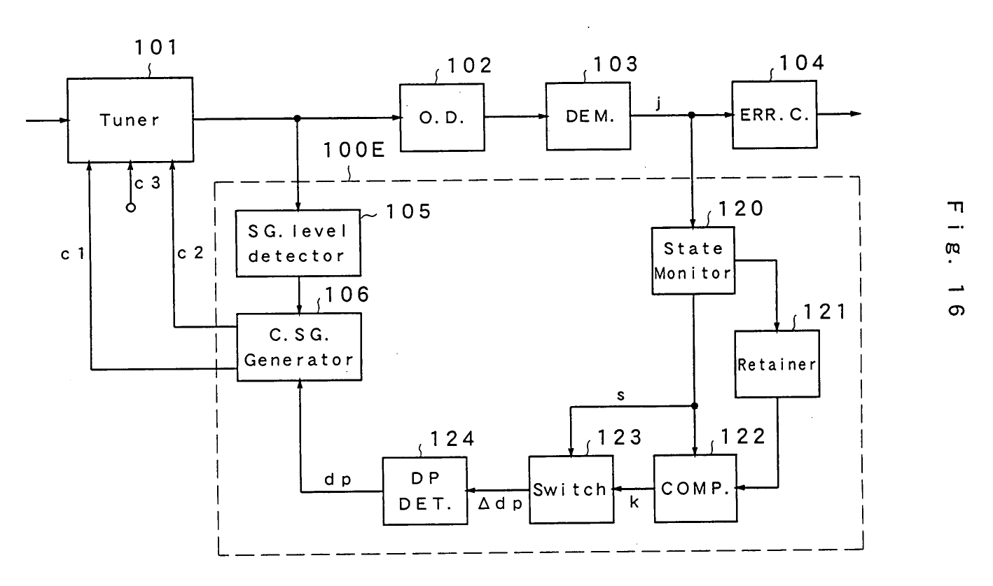

The C/N detector 112 is constituted by a C/N calculation block 112a and a C/N memory block 112b, as shown in FIG. 15. The C/N calculation block 112a calculates carrier electric power and noise electric power on the basis of a demodulation signal j supplied from the demodulator 103, further calculates carrier/noise (C/N) information, and outputs C/N information i1 to the C/N memory block 112b and C/N judgment unit 113. The C/N memory block 112b stores the C/N information i1 supplied from the C/N calculation block 112a and outputs the stored information i1 to the C/N judgment unit 113. The C/N judgment unit 113 generates a C/N judgment signal h2 using the C/N information i1 inputted from the C/N calculation block 112a and C/N information i2 inputted from the C/N memory block 112b, and outputs the signal h2 to the control signal generator 106.

A delay point control according to Embodiment 4 will be described referring to FIGS. 14 and 15. When the interference waves in adjacent channels exist in a certain reception environment, the IF signal d1 supplied the orthogonal detector 102 from the tuner 101 constitutes the signal on the desired channel including the signals on the adjacent channels. The IF signal d1 combining the signals on the desired channel and adjacent channels therein is subject to the orthogonal detection processing and the demodulation processing without any separation process.

The C/N detector 112 calculates the carrier electric power and noise electric power on the basis of the signal from the demodulator 103, and has the C/N memory block 112b storing the C/N information i1 of the calculated signal, in the state of which the delay point is changed. The changed delay point serves to change the RF-AGC control signal c1 fed back to the RF-AGC amplifier 202 of the tuner 101. Because of that, a range of the input level, at which the output of the RF-AGC amplifier 202 is changed without being saturated, changes, and the C/N information i1 calculated in the C/N calculation block 112a accordingly changes. The C/N information i1 calculated in accordance with the change of the delay point and the C/N information i2 calculated prior to the change of the delay point and stored in the C/N memory block 112b are supplied to the C/N judgment unit 113, and the C/N judgment unit 113 compares the supplied information.

When the C/N information i1 calculated after the delay point is changed is larger than the C/N information i2 prior to the change of the delay point, it is indicated that the signal processings are reduced in the region where the output of the RF-AGC amplifier 202 is saturated (nonlinear region) in response to the changed delay point. On the contrary, when the C/N information i2 calculated prior to the change of the delay point is smaller than the C/N information i1 after the delay point change, it is indicated that the signal processings are increased in the region where the output of the RF-AGC amplifier 202 is saturated in response to the changed delay point. The delay point should be changed in such a manner that the signal processings are reduced in the region where the output of the RF-AGC amplifier 202 is always saturated.

When there is no signal processing executed in the region where the output of the RF-AGC amplifier 202 is saturated, that is, when the there is no difference between the C/N information i1 and the stored C/N information i2, it is regarded that there is no interference wave in adjacent channel, and the delay point is not changed.

It is unnecessary to continually renew the delay point. The signal levels of the demodulation level signal b1 are averaged at certain periodical intervals so that the average values can be used to compare the signal levels.

The current C/N information i1 and the stored C/N information i2 are compared in the foregoing description. As an alternative measure, the C/N information i2 showing a significant deterioration of the reception characteristic can be previously stored in the memory, and the current C/N information i1 can be compared with the C/N information i2 read from the memory, so that the delay point is controlled.

Further, in the present embodiment, the level judgment signal a1 to be inputted to the control signal generator 106 is calculated from the IF signal d1 of the tuner 101. The level judgment signal a1 can be calculated from the base band signal from the orthogonal detector 102 onward.

### Embodiment 5

A digital broadcast receiver according to Embodiment 5 of the present invention will be described below referring to FIGS. 16 through 18. FIG. 16 is a view illustrating a configuration of a main part of the digital broadcast receiver according to Embodiment 5 of the present invention. The digital broadcast receiver comprises, as in Embodiment 1, the tuner 101, orthogonal detector 102, demodulator 103, and error detection unit 104, and further comprises an automatic gain controller 100E, which is configured differently compared to the automatic gain controllers according to Embodiments 1 through 4.

The automatic gain controller 100E includes the signal level detector 105, control signal generator 106, a state monitor 120, a retainer 121, a comparator (COMP.) 122, a switch unit 123, and a delay point determination unit (DP.DET.) 124.

The demodulator 103 analogue/digital-converts the complex signals outputted from the orthogonal detector 102 and composed of the I and Q signals and executes a demodulation processing including a synchronous processing to the complex signals, and then outputs the demodulation signal j to the error corrector 104 and the state monitor 120. The state monitor 120 generates a demodulation state signal s representing a demodulation state from the demodulation signal j supplied from the demodulator 103, and outputs the signal s to the retainer 121, a first input end of the comparator 122, and the switch unit 123. The retainer 121 retains the demodulation state signal s supplied from the state monitor 120 for a certain period of time, and supplies the signal s to a second input end of the comparator 122.

The comparator 122 compares a current demodulation state signal si outputted from the state monitor 120 and a previous demodulation state signal sj outputted from the retainer 121, and outputs the comparison result to the switch unit 123.

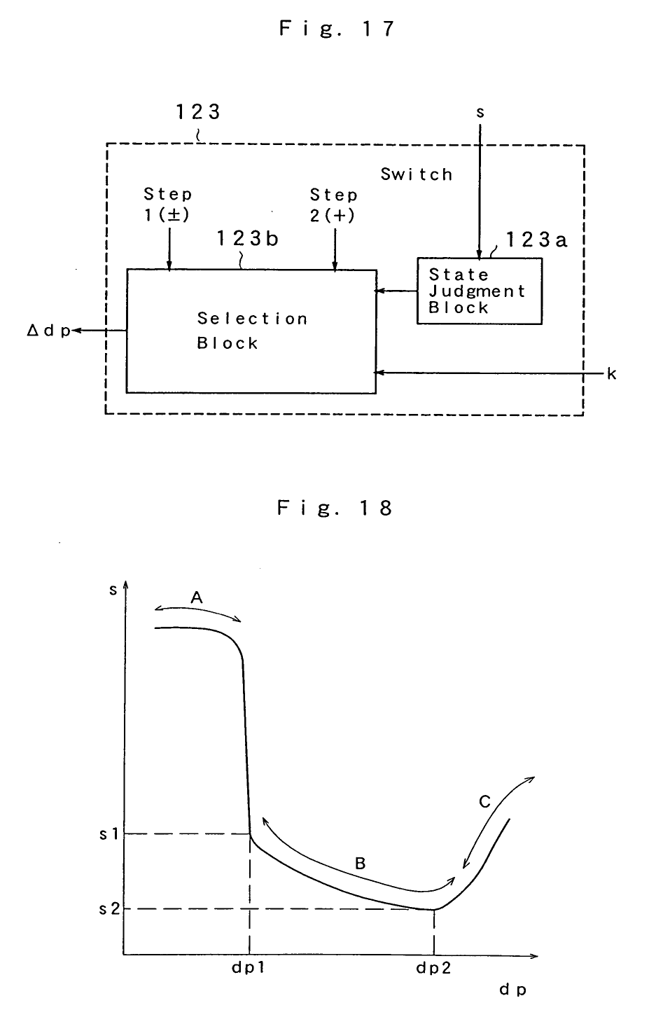

The switch unit 123 includes a state judgment block 123a and a selection block 123b, as shown in FIG. 17. The state judgment block 123a judges whether the demodulation state is good or poor by using the demodulation state signal s supplied from the state monitor 120 of FIG. 16, and outputs the judgment result to the selection block 123b. The selection block 123b determines the variation step width of the delay point Δdp on the basis of the judgment result supplied from the state judgment block 123a and a comparison signal k supplied from the comparator 122, and outputs the variation step as the step signal to the delay point determination unit 124. The delay point determination unit 124 renews and determines the delay point value on the basis of the variation of the delay point and includes a counter.

The delay point determination unit 124 increases or decreases the delay point value in accordance with the step signal supplied from the switch unit 123, and outputs the delay point value as the signal of the delay point value dp to the control signal generator 106. The signal level detector 105 detects the signal level of the IF signal supplied from the tuner 101, and outputs the signal level as a reception level signal to the control generation unit 106.

The control signal generator 106 determines a control function on the basis of the delay point value dp supplied from the delay point determination unit 124, and outputs the RF-AGC control signal c1 to the RF-AGC amplifier 202 in the tuner 101 and an IF-AGC control signal c2 to an IF-AGC amplifier 210 in accordance with the reception level signal supplied from the signal level detector 105.

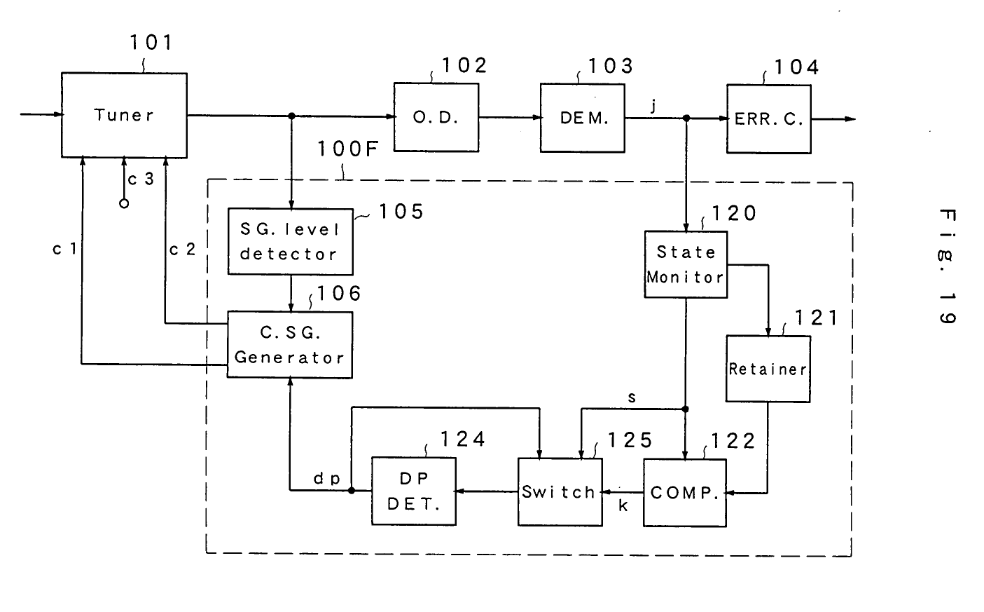

A method of the delay point control according to the present embodiment will be described referring to FIGS. 17 and 18. As an example, the demodulation state signal s, such as the error rate and noise volume which becomes a larger value as the influence from interference wave in adjacent channels increases, is set. A controlling method using the demodulation state signal s will be described below. A first threshold value of the demodulation state signal s is s1, and a reference is made to the case that the demodulation state is relatively good (s≦s1) with a small influence from the interference wave in adjacent channels. This case corresponds to a region B in FIG. 18, in which, the state judgment block 123a judges the demodulation state to be good on the basis of the demodulation state signal s supplied from the state monitor 120. The selection block 123b selects a step width 1 having a small variation range on the basis of the comparison signal supplied from the comparator 122, and outputs the value as the step signal to the delay point determination unit 124 shown in FIG. 16. In this manner, for example, the delay point value dp1 of FIG. 18 can finally converge with an optimum value dp2.

Meanwhile, when the influence from the interference wave in adjacent channels is large and the demodulation state is significantly deteriorated with (s>s1) as shown in a region A of FIG. 18, the variation range of the step width 1 cannot induce any distinct difference in the demodulation state. Then, the state judgment block 123a judges the demodulation state to be deteriorating on the basis of the demodulation state signal s supplied from the state monitor 120, and the selection block 123b outputs the step signal of a positive step width 2 having a variation range larger than that of step width 1 to the delay point determination unit 124 irrespective of the comparison signal supplied from the comparator 122. The step signal of the step width 2 having the larger variation range is used so that the reception state transits from the region of s>s1 to the region of s<s1, which are shown in FIG. 18. Thus, a distinct difference is generated between the demodulation states before and after the transition of the delay point, and the delay point control on the basis of the comparison signal from the comparator 122 is effectively operated. In the case in which the demodulation state is poor with s>s1, because the demodulation state signal s needs to be changed to enable the state where the comparison is implemented, it is unnecessary to find the optimum delay point allowing the delay point to be subject to a unidirectional control to be only increased.

When the delay point becomes far larger than the foregoing state, the reception characteristic can possibly deteriorate due to the NF, as shown in a region C of FIG. 18. In this case, in order to arrange the demodulation state signal to be a certain value, which does not lead to the deterioration of the reception characteristic due to the NF, a threshold value is previously set up in the delay point determination unit 124 so that the delay point does not exceed a certain value, that is, threshold value in addition to the before-mentioned operation. It is advantageous to clip the demodulation state signal s at the threshold value in improving the reception characteristic. The control signal generator 106 controls the gain of the RF signal and the gain of the IF signal on the basis of the delay point value and the signal level of the reception signal.

### Embodiment 6

A digital broadcast receiver according to Embodiment 6 of the present invention will be described referring to the drawings. FIG. 19 is a view illustrating a configuration of a main part of the digital broadcast receiver according to Embodiment 6. The digital broadcast receiver includes, in addition to the tuner 101, orthogonal detector 102, demodulator 103 and error corrector 104 as in Embodiment 1, an automatic gain controller 100F having a configuration different from the automatic gain controllers according to Embodiments 1 through 4.

The automatic gain controller 100F includes the signal level detector 105, control signal generator 106, state monitor 120, retainer 121, comparator 122, a switch unit 125, and the delay point determination unit 124.

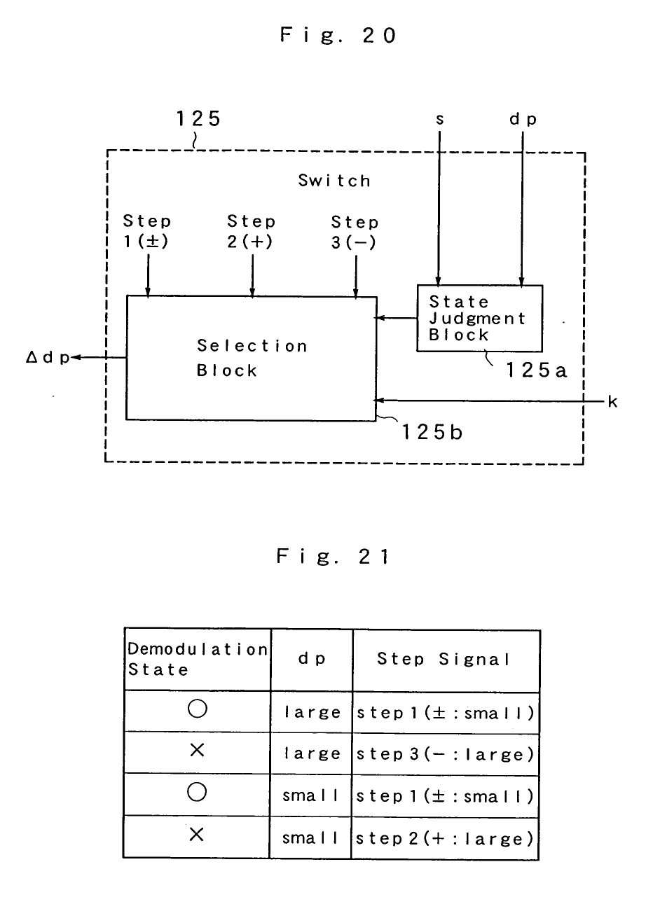

The switch unit 125 includes a state judgment block 125a and a selection block 125b, as shown in FIG. 20. The state judgment block 125a judges whether the demodulation state is good or poor by using the demodulation state signal supplied from the state monitor 120 and the delay point value dp outputted from the delay point determination unit 124, as shown in FIG. 19, and outputs the judgment result to the selection block 25b.

The selection block 125b determines variation range Adp of the delay point dp on the basis of the judgment result supplied from the state judgment block 125a and the comparison signal k supplied from the comparator 122, and outputs the determined variation range Adp as the step signal to the delay point determination unit 124 of FIG. 19. The delay point determination unit 124 increases or decreases the delay point value in accordance with the step signal supplied from the switch unit 125, and generates the delay point value dp, and outputs the delay point dp to the control signal generator 106 and the state judgment block 125a in the switch unit 125.

A delay point control method according to the present embodiment will be described referring to FIGS. 19 through 21. As an example, a reference is made to the case in which there is some influence from the interference wave in adjacent channels is. The control implemented when the delay point value is under as shown in the region A and B of FIG. 18 is the same as the control method according to Embodiment 5. In the area where the delay point is larger than dp2, a negative step width 3 having a variation range larger than that of the step width 1 is provided in the selection block 125b in the switch unit 125, as shown in FIG. 20, in order to prevent the reception characteristic from deteriorating due to the NF.

When the delay point value dp and the demodulation state signal s are both large, a step signal which the variation range is longer than that of the step width 1, and decreases delay point value dp is outputted to the delay point determination unit 124. It is advantageous to use the negative step signal having the large variation range in terms of improving the reception characteristic when the reception characteristic deteriorates due to the NF because of too a large delay point value dp. In using the selection block 125b of three options such as the step width 1, step width 2, and step width 3, the high interference suppression and low noise characteristics can be both achieved. FIG. 21 shows the step signal in accordance with the demodulation state signal s and delay point value dp.

### Embodiment 7

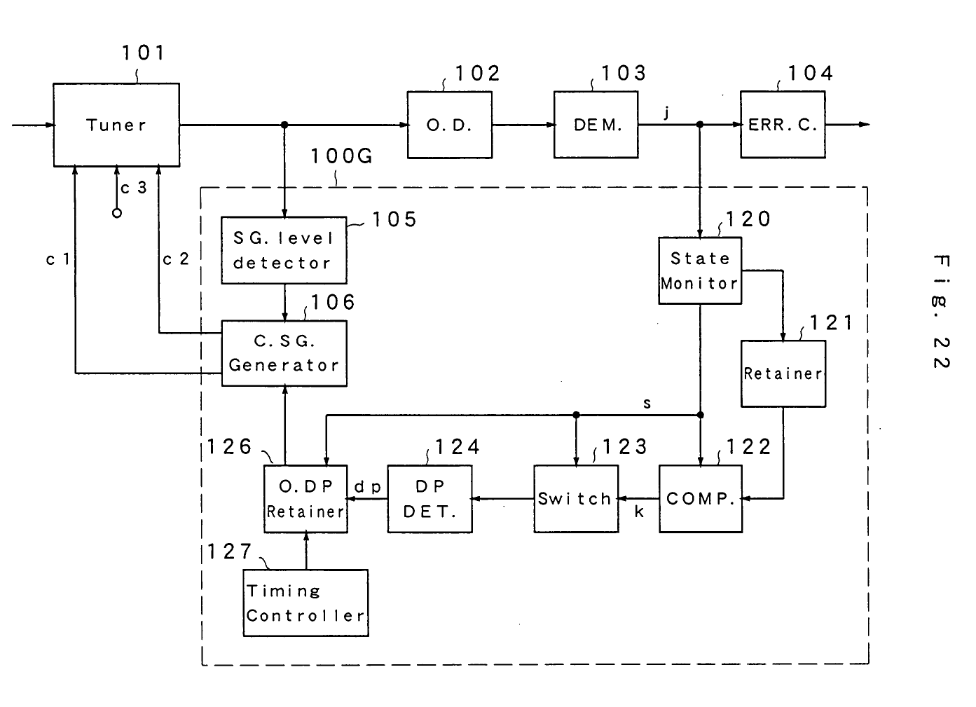

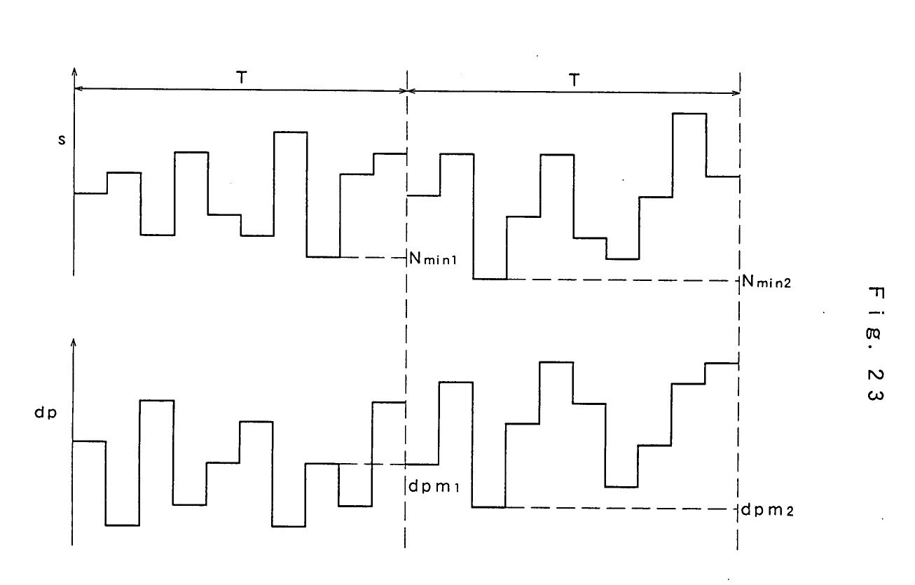

A digital broadcast receiver according to Embodiment 7 of the present invention will be described referring to the drawings. FIG. 22 is a view illustrating a configuration of a main part of the digital broadcast receiver according to this embodiment.

The digital broadcast receiver comprises the tuner 101, orthogonal detector 102, demodulator 103, error corrector 104 as in the configuration according to Embodiment 1, and further comprises an automatic gain controller 100G configured in a manner different from the automatic gain controllers according to Embodiments 1 through 6.

The automatic gain controller 100G includes the signal level detector 105, control signal generator 106, state monitor 120, retainer 121, comparator 122, switch unit 123, delay point determination unit 124, an optimum delay point (O.DP.) retainer 126, and a timing controller 127.

The optimum delay point retainer (hereinafter, referred to as optimum DP retainer) 126 retains the signal of the delay point value dp outputted from the delay point determination unit 124, and further retains the demodulation state signal s outputted from the state monitor 120. The optimum DP retainer, when provided with a timing signal from the timing controller 127, selects an optimum delay point value dp and outputs the optimum delay point value dp to the control signal generator 106. Any other component is identical to those in the configuration shown in FIG. 16, and a description of the identical components is thereby omitted here.

The functions of the optimum DP retainer 126 and timing controller 127 are described referring to FIG. 23. Renewal intervals of the demodulation state signal s are same as the renewal intervals of the step signal outputted from the switch unit 123, and also same as the renewal intervals of the delay point value provided for the optimum DP retainer 126 by the delay point determination unit 124. The demodulation state signal and the signal of the delay point value change per the foregoing renewal period in the same manner as in the digital broadcast receiver according to Embodiment 5. However, the delay point value dp may not settle at a constant value when the environment the digital broadcast receiver is used changes over time, as in the case of a mobile reception.

A length of time n times (n is an integer) as long as the renewal interval of the delay point is a period T, and the optimum delay point is obtained per period T. The automatic gain controller is then operated with the obtained delay point as a point when the delay point starts to change in a next period. More specifically, as shown in FIG. 23, a minimum value of the demodulation state signal s in a block of time t=0 to T is Nmin1. The optimum DP retainer 126 obtains a delay point value dpm1 when the minimum value Nmin1 is taken, and stores and retains the value dpm1. Then, the delay point control as described in Embodiment 5 is implemented with the value dpm1 as a starting point dpm1 when the delay point starts to change in a block of the next period T, that is t=T to 2T.

In t=2T to 3T, the delay point value when a minimum value Nmin2 of the demodulation state signal s is obtained as dpm2, is stored and retained in the same manner. The dpm2 is set to be a point when the delay point starts to change in t=3T to 4T. The foregoing operation is repeated so that the demodulation state signal s gradually changes to converge with a minimum (optimum) value in the reception environment, and the delay point, in response to the change, converges as well.

### Embodiment 8

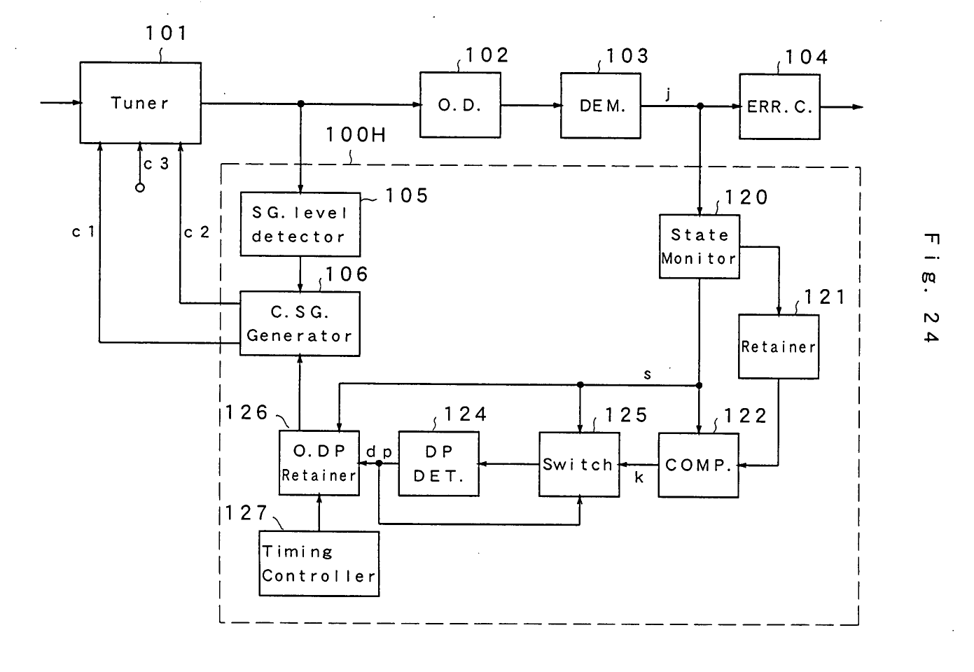

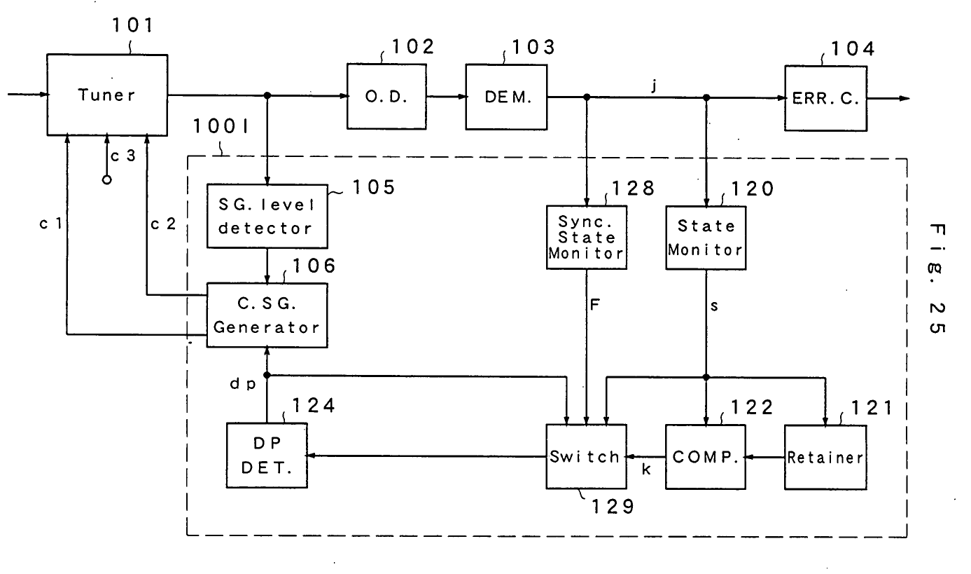

A digital broadcast receiver according to Embodiment 8 of the present invention will be described below referring to the drawings. FIG. 24 is a view illustrating a configuration of a main part of the digital broadcast receiver according to Embodiment 8.

The digital broadcast receiver comprises the tuner 101, orthogonal detector 102, demodulator 103, error corrector 104 as in the configuration according to Embodiment 1, and further comprises an automatic gain controller 100H configured in a manner different from the automatic gain controllers according to Embodiments 1 through 6.

The automatic gain controller 100H consists of the signal level detector 105, control signal generator 106, state monitor 120, retainer 121, comparator 122, switch unit 125, delay point determination unit 124, optimum delay point retainer 126, and timing controller 127.

The optimum delay point retainer (hereinafter, referred to as optimum DP retainer) 126 retains the signal of the delay point value dp supplied from the delay point determination unit 124, and further retains the demodulation state signal s outputted from the state monitor 120. The optimum DP retainer 126, when provided with the timing signal by the timing controller 127, outputs the delay point dp to the control signal generator 106.

In the digital broadcast receiver according to the present embodiment, the delay point determination unit 124 outputs the delay point value dp to the switch unit 125. The digital broadcast receiver is capable of suppressing the distortion of the signal caused by interference wave in adjacent channel by outputting the step signal selected in the selection block 125 shown in FIG. 20 to the delay point determination unit 124, and is further capable of preventing the reception characteristic from deteriorating due to the increased NF.

### Embodiment 9

A digital broadcast receiver according to Embodiment 9 of the present invention will be described below referring to the drawings. FIG. 25 is a view illustrating a configuration of a main part of the digital broadcast receiver according to Embodiment 9.

The digital broadcast receiver comprises the tuner 101, orthogonal detector 102, demodulator 103, error corrector 104 as in the configuration according to Embodiment 1, and further comprises an automatic gain controller 100I configured in a manner different from the automatic gain controllers according to Embodiments 1 through 6.

The automatic gain controller 100I consists of the signal level detector 105, control signal generator 106, state monitor 120, retainer 121, comparator 122, delay point (DP) determination unit 124, a synchronous state monitor 128, and a switch unit 129.

The synchronous state monitor 128 monitors a synchronous state in consequence of the synchronous processing executed in the demodulator 103, and outputs a control start flag F to the switch unit 129 so that the delay point control starts when a demodulated signal gets in predetermined synchronous state. The synchronous state monitor 128 output the control start flag F to the switch unit 129 so that delay point control is started with a certain length of time after the demodulated signal gets in the predetermined synchronous state.

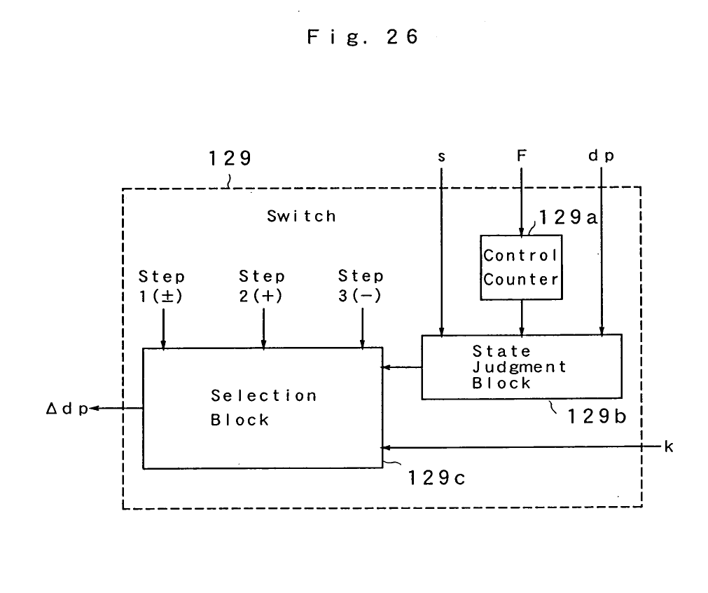

The switch unit 129 includes a control counter 129a, a state judgment block 129b and a selection block 129c, as shown in FIG. 26. The control counter 129a is reset by means of the control start flag F supplied from the synchronous state monitor 128, and thereafter executes a counting and a control number N is counted up every time when the step signal outputted from the switch unit 129 is renewed. The control counter 129a then outputs the control number N to the state judgment block 129b. The state judgment block 129b judges whether the demodulation state is good or poor using the demodulation state signal s supplied from the state monitor 120 and the delay point value dp supplied from the delay point determination unit 124, which are shown in FIG. 19, and the control number N supplied from the control counter 129a, and outputs the judgment result to the selection block 129c.

The selection block 129c determines the step signal for deciding the variation range Δdp of the delay point value dp on the basis of the judgment result supplied from the state judgment block 129b and the comparison signal k supplied from the comparator 122, and outputs the value to the delay point determination unit 124 of FIG. 25. The delay point determination unit 124 increases or decreases the delay point value in accordance with the step signal supplied from the switch unit 129, and outputs the delay point value dp to the control signal generator 106 and the state judgment block 129b in the switch unit 129.

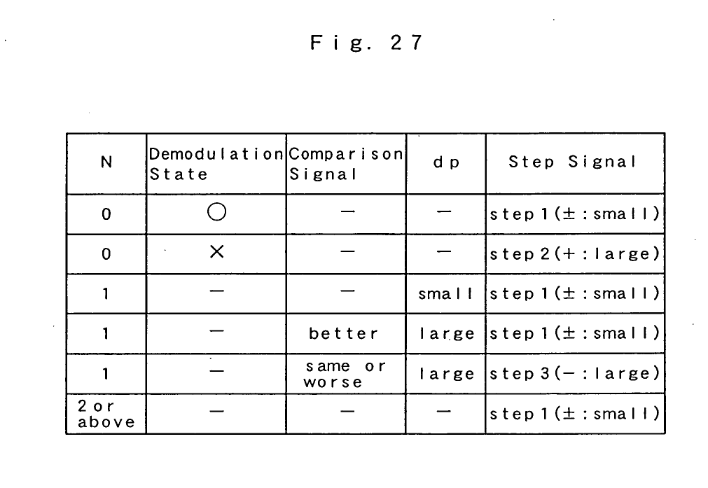

A method of controlling the delay point according to the present embodiment will be described referring to FIG. 27.

First, when the control number N is 0, that is, immediately after the start of the control and when the demodulation state signal s is small, the step width 1 is outputted to the delay point determination unit 124 as the step signal. Hereinafter, when the control number N is 1 or above, the step width 1 is exclusively outputted to the delay point determination unit 124 as the step signal. This is because the delay point is not unnecessarily increased in the absence of the interference wave in adjacent channels to prevent the resultant deterioration of the NF.

When the control number N is 0 and the demodulation state signal s is large, step width 2 whose variation range is larger than that of the step width 1 is selected and outputted to the delay point determination unit 124 as the step signal on the basis of the judgment that interference wave in adjacent channels possibly exist. The variation range of step width 2 is larger than that of the step width 1, and step direction is only positive.

When the control number N is 1, and the delay point value dp is large, and the comparison signal indicates the same or worse demodulation state, step width 3 which is negative step is selected, and the variation range of step width 3 is larger than that of the step width 1 is outputted to the delay point determination unit 124 as the step signal on the basis of the judgment that the change of the delay point value dp does not contribute to the improvement of the performance.

When the control number is 1, and the delay point value dp is large, and the comparison signal indicates better demodulation state, the step width 1 is outputted to the delay point determination unit 124 as the step signal on the basis of the judgment that interference wave in adjacent channels exist.

When the control number N is 2 or above, the step width 1 is exclusively outputted to the delay point determination unit 124 as the step signal.

In the described manner of comparing the respective demodulation states when the delay point value is small and large, the presence or absence of the interference wave in adjacent channels is promptly judged, thereby the convergence with the optimum delay point value is accelerated.

### Embodiment 10

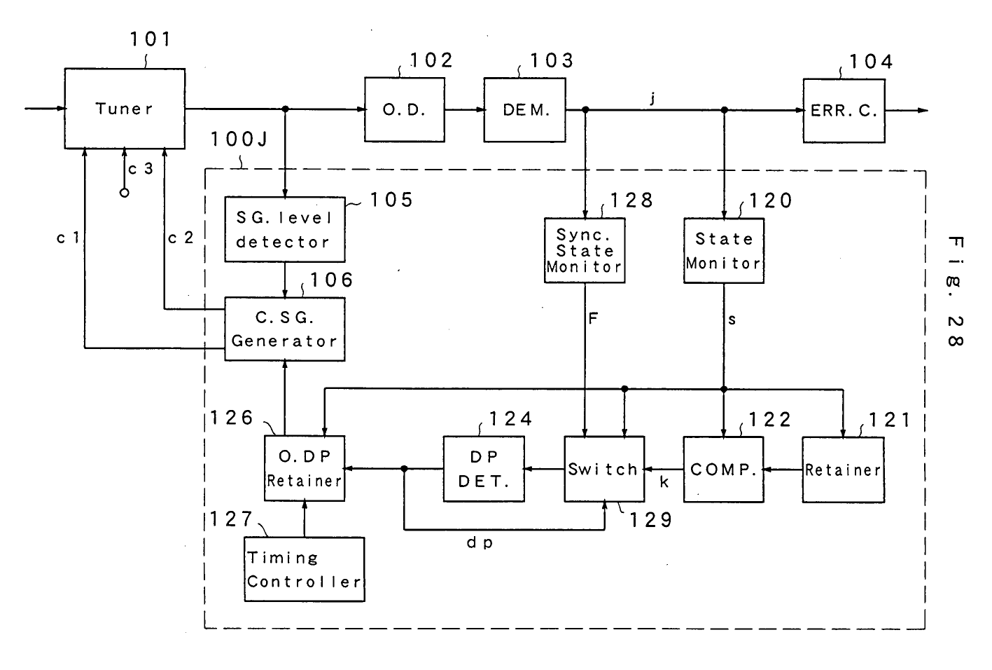

A digital broadcast receiver according to Embodiment 10 of the present invention will be described below referring to the drawings. FIG. 28 is a view illustrating a configuration of a main part of the digital broadcast receiver according to Embodiment 10.

The digital broadcast receiver comprises the tuner 101, orthogonal detector 102, demodulator 103, and error corrector 104 as in the configuration according to Embodiment 1, and further comprises an automatic gain controller 100J configured in a manner different from the automatic gain controllers according to Embodiments 1 through 6.

The automatic gain controller 100J consists of the signal level detector 105, control signal generator 106, state monitor 120, retainer 121, comparator 122, delay point determination unit 124, optimum DP retainer 126, timing controller 127, synchronous state monitor 128, and switch unit 129.

The optimum DP retainer 126 retains the signal of the delay point value dp supplied from the delay point determination unit 124 and also retains the demodulation state signal s outputted from the state monitor 120. The optimum DP retainer 126 further, when the timing signal is supplied from the timing controller 127, outputs the delay point value dp to the control signal generator 106. Any other component is identical to those in the configuration shown in FIG. 25, and a description of the identical components is thereby omitted here.

The optimum DP retainer 126 and timing controller 127 function in the same manner as in the digital broadcast receiver according to Embodiment 7. The digital broadcast receiver according to the present embodiment outputs the signal of the delay point value dp outputted from the delay point determination unit 124 to the switch unit 129. The digital broadcast receiver is capable of suppressing the distortion of the signal due to the interference wave in adjacent channels by outputting the step signal selected in the selection block 129c of FIG. 26 to the delay point determination unit 124. Further, the reception characteristic can be prevented from deteriorating due to the increase of the NF.

In the thus far described embodiments, the digital broadcast receiver was described with a focus on the automatic gain controller, however the present invention is not limited thereto. The present invention is also applicable to an automatic gain controller of a wireless transmission receiver using the OFDM transmission method.

Embodiments 2, 3, and 4 are not limited to the automatic gain controller of the digital broadcast receiver using the OFDM transmission method, and also applicable to the automatic gain controller of the wireless transmission receiver.

In the digital broadcast receiver capable of a mobile reception in addition to the stationary reception, the more stable reception characteristic can be obtained by shortening the renewal intervals of the delay point in the mobile reception compared to the same in the stationary reception.

Further, in the digital broadcast receivers according to Embodiments 7, 8 and 10, the value of the timing signal outputted from the timing controller 127 is not necessarily a fixed value, and is subject to change depending on an environment of the usage and reception.

Further, in the digital broadcast receivers according to Embodiments 5 through 10, the delay point control employs the larger step width, which is different from the step widths positively or negatively changed at a small rate. However, the digital broadcast receivers are not limited to the provision of one variation range with the large step width, and a plurality of step widths having different variation ranges can be provided to enable the step signal to be selected on the basis of more specific terms. In this manner, the convergence with the optimum delay point value can be accelerated.

Further, in the digital broadcast receivers according to Embodiments 5 through 10, the step width used for the delay point control may not always employ the fixed value, and may be subject to change depending on a length of time elapsing after the control starts and the control number. The digital broadcast receivers according to Embodiments 5 through 10 may gradually reduce the step width used for the delay point control depending on the length of time elapsing after the control starts and the control number. In this manner, the performance is prevented from deteriorating due to a drastic change of the delay point value.

Further, in the delay point control executed in the digital broadcast receivers according to Embodiments 5 through 10, in order to control the deterioration of the NF, the delay point value is previously set at the small value, and the step signal is switched so as to increase the delay point value to the larger values in accordance with the reception environment. On the contrary, the delay point value may be previously set at a large value, and the step signal may be switched so as to decrease the delay point value to smaller values to thereby search the optimum delay point value.

Further, in the digital broadcast receivers according to Embodiments 5 through 10, referring to the delay point control, it will be described that the demodulation state signal becomes larger as the reception state is more deteriorated, however the demodulation state signal such as CNR (Carrier to Noise Ratio) can be arranged to become smaller as the reception state is more deteriorated.

Further, in the digital broadcast receivers according to Embodiments 5 through 10, referring to the delay point control, the automatic gain control on the basis of the signal level prior to the demodulation will be described, however the automatic gain control in accordance with the signal level after the demodulation is also usable.

Further, in the digital broadcast receivers according to Embodiments 5 through 10, the delay point control in the automatic gain controller is not always necessary. The delay point control can be possibly terminated after a certain period of time in order to reduce power consumption. Further, in the automatic gain controllers of the digital broadcast receivers according to Embodiments 1 through 6, the delay point control can be temporarily halted after a certain period of time, and restarted after a certain period of time.

Further, in the digital broadcast receivers according to Embodiments 5 through 10, the delay point control can be temporarily halted after a certain period of time, and restarted when the demodulation state is deteriorated. This successfully contributes to both flexible responses to the changing reception environment and power saving.

### INDUSTRIAL APPLICABILITY

The digital broadcast receiver according to the present invention incorporates therein an automatic gain controller having a low noise characteristic and a characteristic for suppressing interferences due to adjacent channels, and is advantageous as a receiver in digital TV broadcasts and digital radio broadcasts. The digital broadcast receiver according to the present invention is capable of further improving a control of receiving signal level of a tuner having a dual AGC function, particularly in an environment where simultaneous broadcasts are transmitted. The digital broadcast receiver according to the present invention can be suitably used not only in the environment of the simultaneous broadcasts but also where a number of digital broadcast channels are adjacent to one another.

1. A digital broadcast receiver comprising:
a tuner which amplifies an input signal to select a RF signal on a desired band and amplifies the RF signal to frequency-convert the RF signal into an IF signal;
an orthogonal detector which calculates I and Q complex signals from the IF signal of said tuner;
a demodulator which demodulates a digital signal from the I and Q complex signals of said orthogonal detector; and
an automatic gain controller which detects a signal level of a reception signal from the IF signal of said tuner, detects a demodulation state in said demodulator, judges a level of an influence from interference waves in adjacent channels affecting on a demodulation signal on the desired band, generates a gain control signal on a RF band and a gain control signal on an IF band in accordance with the level of the influence and the signal level of said the reception signal, and feeds back the both gain control signals to said tuner.

2. A digital broadcast receiver according to claim 1, wherein
said automatic gain controller comprises:
a signal level detector which detects the signal level of the reception signal from the IF signal of said tuner;
a demodulation level detector which detects a demodulation level signal of the demodulation signal on the desired band from a demodulation output of said demodulator;
a demodulation level judgment unit which generates a demodulation level judgment signal representing the influence from the interference waves in adjacent channel affecting on the demodulation signal on the desired channel from the demodulation level signal of the demodulation level detector; and
a control signal generator which generates the gain control signal on the RF band and the gain control signal on the IF band in accordance with the demodulation level judgment signal of said demodulation level judgment unit and the signal level of said signal level detector to feed back the both gain control signals to said tuner, and said tuner includes:
a RF-AGC amplifier which controls a level of the RF signal on the basis of the gain control signal on the RF band; and
an IF-AGC amplifier which controls a level of the IF signal on the basis of the gain control signal on the IF band.

3. A digital broadcast receiver according to claim 2, wherein
the demodulation level detector includes:
a demodulation band extraction block which extracts a signal on the desired band from a frequency signal Fourier-converted in said demodulator;
a demodulation level calculation block which calculates a level of the signal on the desired band obtained in said demodulation band extraction block; and
a demodulation level memory block which retains the level of the signal on the desired band prior to a change of a delay point when a point of switching between the gain control signal on the RF band and the gain control signal on the IF band in said tuner is set to be the delay point, and
said demodulation level detector compares the level of the signal on the desired band prior to a change of a delay point with the level of the signal on the desired band after the change of the delay point to judge the level of the influence from the interference waves in adjacent channels affecting on the desired band.

4. A digital broadcast receiver according to claim 3, wherein
said demodulation band extraction block extracts only a frequency band, on which third-order distortion due to a signal outside the desired band appears.

5. A digital broadcast receiver according to claim 3, wherein
said demodulation band extraction block extracts only a frequency band, on which third-order distortion due to a NTSC signal appears.

6. A digital broadcast receiver according to claim 1, wherein
a time axis filter which extracts a signal on the desired band from the I and Q signals of the demodulator is provided between the orthogonal detector and the demodulator,
said automatic gain controller includes:
a signal level detector which detects the signal level of the reception signal from the IF signal of said tuner;
a detection level calculator which calculates a level of the signal on the desired band from an output signal of said time axis filter;
a signal level judgment unit which generates a signal level judgment signal representing the influence from the interference waves in adjacent channels affecting on the signal on the desired band from the level of the signal on the desired band obtained by said detection level calculator and the signal level obtained by said signal level detector; and
a control signal generator which feeds back the gain control signal on the RF band and the gain control signal on the IF band in accordance with the signal level judgment signal of said signal level judgment unit and the signal level of said signal level detector to said tuner, and
said tuner includes:
a RF-AGC amplifier which controls a level of the RF signal on the basis of the gain control signal on the RF band; and
an IF-AGC amplifier which controls a level of the IF signal on the basis of the gain control signal on the IF band.

7. A digital broadcast receiver according to claim 1, wherein
said tuner includes a RF-AGC amplifier which controls a level of the RF signal on the basis of the gain control signal on the RF band and an IF-AGC amplifier which controls a level of the IF signal on the basis of the gain control signal on the IF band, amplifies the input signal to select the RF signal on the desired band, amplifies the RF signal to frequency-convert the RF signal into the IF signal, and generates a adjacent judgment signal representing the influence from the interference waves in adjacent channel affecting on a signal on the desired band, and
said automatic gain controller includes a control signal generator which feeds backs the gain control signal on the RF band and the gain control signal on the IF band to said tuner in accordance with the adjacent judgment signal of said tuner and the signal level of said signal level detector.

8. A digital broadcast receiver according to claim 7, wherein
said tuner includes, in addition to the RF-AGC amplifier and the RF-AGC amplifier:
a first level detection block which calculates a signal level of a first intermediate frequency signal frequency-converted into an intermediate frequency;
a band limitation filter which limits the band of the first intermediate frequency signal and converts the first intermediate frequency signal into a second intermediate frequency signal;
a second level detection block which calculates a signal level of the second intermediate frequency signal; and
a adjacent judgment block which compares the signal levels of the first and second intermediate frequency signals to judge the influence from the adjacent interference waves in adjacent channels affecting on the desired band.

9. A digital broadcast receiver according to claim 1, wherein
said automatic gain controller includes:
a C/N detector which calculates C/N from the demodulation signal of said demodulator;
a C/N judgment unit which generates C/N judgment signal representing the influence from the interference waves in adjacent channels affecting on a signal on the desired band from C/N information of said C/N detector;
a signal level detector which detects the signal level of the reception signal from the IF signal of said tuner; and
a control signal generator which feeds back the gain control signal on the RF band and the gain control signal on the IF band to said tuner in accordance with the signal level of said signal level detector and the C/N judgment signal of said C/N judgment unit, and
said tuner includes:
a RF-AGC amplifier which controls a level of the RF signal on the basis of the gain control signal on the RF band; and
an IF-AGC amplifier which controls a level of the IF signal on the basis of the gain control signal on the IF band.

10. A digital broadcast receiver according to claim 9, wherein
said C/N detector includes:
a C/N calculation means which calculates C/N information from the demodulation signal of said demodulator; and
a C/N memory means which stores the C/N information of said C/N calculation means, and
said C/N judgment means compares the C/N information before a change of a delay point with the C/N information after the change of the delay point to judge the influence from the interference waves in adjacent channels affecting on the desired band when a point of switching between the gain control signal on the RF band and the gain control signal on the IF band in said tuner is set to be the delay point.

11. A digital broadcast receiver according to claim 10, wherein
said C/N detector compares the C/N information calculated in the C/N calculation means with fixed C/N information previously stored in a memory.

12. A digital broadcast receiver according to claim 1, wherein
said automatic gain controller includes:
a state monitor which detects the demodulation state from a demodulation output of said demodulator to generate a demodulation state signal;
a retainer which retains the demodulation state signal outputted from said state monitor for a certain period of time;
a comparator which compares the demodulation state signal outputted from said state monitor with the demodulation state signal retained by said retainer to output a comparison signal representing a variation of the demodulation state after the elapse of a certain period of time;
a switch unit which determines a variation of a delay point on the basis of the comparison signal of said comparator and the demodulation state signal obtained by the state monitor so as to select a step width of small variation range when the demodulation state is good and a step width of large variation range when the demodulation state is poor, when a point of switching between the gain control signal on the RF band and the gain control signal on the IF band in said tuner is set to be the delay point;
a delay point determination unit which renews a value of the delay point from the variation of the delay point determined by said switch unit;
a signal level detector which detects the signal level of the reception signal from the IF signal of said tuner; and
a control signal generator which generates the gain control signal on the RF band and the gain control signal on the IF band from the delay point value of said delay point determination unit and the signal level of said signal level detector.

13. A digital broadcast receiver according to claim 12, wherein
said switch unit includes:
a reception state judgment block which judges a reception state from the demodulation state signal; and
a selection block which determines the variation of the delay point from the comparison result of said comparator and the judgment result of said reception state judgment block.

14. A digital broadcast receiver according to claim 12, wherein
the switch unit includes:
a reception state judgment block which judges a reception state from the demodulation state signal and the delay point value; and
a selection block which determines the variation of the delay point from the comparison result of said comparator and the judgment result of said reception state judgment block.

15. A digital broadcast receiver according to claim 13, wherein
the selection block selects and determines a specific variation of the delay point from a plurality of different delay point variations.

16. A digital broadcast receiver according to claim 15, wherein
the plurality of delay point variations selected in the selection block include at least one value significantly different from the other variations.

17. A digital broadcast receiver according to claim 1, wherein
said automatic gain controller includes:
a state monitor which detects the demodulation state from a demodulation output of the demodulator to generate a demodulation state signal;
a retainer which retains the demodulation state signal outputted from said state monitor for a certain period of time;
a comparator which compares the demodulation state signal outputted from said state monitor with the demodulation state signal retained by said retainer to output a comparison signal representing a temporal transition of the demodulation state;
a switch unit which determines a variation of a delay point on the basis of the comparison signal of said comparator and the demodulation state signal obtained in the state monitor when a point of switching between the gain control signal on the RF band and the gain control signal on the IF band in said tuner is set to be the delay point;
a delay point determination unit which renews a value of the delay point from the variation of the delay point determined in said switch unit;
a timing controller which generates a timing control signal which is generated per a period which is several times of period when renewing a value of the delay point in said delay point determination unit;
an optimum delay point retainer which detects an optimum delay point within said period of time from the value of the delay point of said delay point determination unit, the demodulation state signal of said state monitor, and the timing control signal of said timing controller and outputs a value of the optimum delay point for following the changes of reception state;
a signal level detector which detects the signal level of the reception signal from the IF signal of said tuner; and
a control signal generator which generates the gain control signal on the RF band and the gain control signal on the IF band from the value of the optimum delay point retained by said optimum delay point retainer and the signal level of the reception signal of said signal level detector.

18. A digital broadcast receiver according to claim 17, wherein
said optimum delay point retainer stores and retains an optimum demodulation state within a time period of the control by said timing controller and the value of the optimum delay point at that time.

19. A digital broadcast receiver according to claim 17, wherein
said optimum delay point retainer renews the value of the optimum delay point stored and retained per a time period of the control by said timing controller.

20. A digital broadcast receiver according to claim 17, wherein
said switch unit includes:
a reception state judgment block which judges a reception state from the demodulation state signal; and
a selection block which determines the variation of the delay point from the comparison result of the comparator and the judgment result of said reception state judgment block.

21. A digital broadcast receiver according to claim 17, wherein
the switch unit includes:
a reception state judgment block which judges a reception state from the demodulation state signal and the delay point value; and
a selection block which determines the variation of the delay point from the comparison result of said comparator and the judgment result of said reception state judgment block.

22. A digital broadcast receiver according to claim 20, wherein
said selection block selects and determines a specific variation of the delay point from.

23. A digital broadcast receiver according to claim 22, wherein
the plurality of delay point variations selected in said selection block include at least one value significantly different from the other variations.

24. A digital broadcast receiver according to claim 1, wherein
said automatic gain controller includes:
a state monitor which detects the demodulation state from a demodulation output of said demodulator to generate a demodulation state signal;
a retainer which retains the demodulation state signal outputted from said state monitor for a certain period of time;
a comparator which compares the demodulation state signal outputted from said state monitor with the demodulation state signal retained in said retainer to output a comparison signal representing a temporal transition of the demodulation state;
a synchronous state monitor which detects a synchronous state from the output of the demodulator to generate a control start flag;
a switch unit which determines a variation of a delay point on the basis of the comparison signal of said comparator, the demodulation state signal obtained in said state monitor, and the control start flag obtained in said synchronous state monitor when a point of switching between the gain control signal on the RF band and the gain control signal on the IF band in said tuner is set to be the delay point;
a delay point determination unit which renews a value of the delay point from the variation of the delay point determined in said switch unit;
a signal level detector which detects the signal level of the reception signal from the IF signal of said tuner; and
a control signal generator which generates the gain control signal on the RF band and the gain control signal on the IF band from the value of the delay point of said delay point determination unit and the signal level of said signal level detector.

25. A digital broadcast receiver according to claim 24, wherein
the switch unit includes:
a control counter which is reset in response to the control start flag obtained in said synchronous state monitor and executes a counting every time when the variation of the delay point outputted from said switch unit is renewed, thereby counting up a control number;
a state judgment block which judges a reception state from the demodulation state signal, the value of the delay point, and the control number; and
a selection block which determines the variation of the delay point from a comparison result of said comparator and a judgment result of said state judgment block.

26. A digital broadcast receiver according to claim 25, wherein
the selection block selects and determines a specific variation of the delay point from a plurality of different delay point variations.

27. A digital broadcast receiver according to claim 26 wherein
the plurality of delay point variations selected by said selection block include at least one value significantly different from the other variations.

28. A digital broadcast receiver according to claim 1, wherein
the automatic gain controller includes:
a state monitor which detects the demodulation state from a demodulation output of the demodulator to generate a demodulation state signal;
a retainer which retains the demodulation state signal outputted from said state monitor for a certain period of time;
a comparator which compares the demodulation state signal outputted from said state monitor with the demodulation state signal retained in said retainer to output a comparison signal representing a temporal transition of the demodulation state;
a synchronous state monitor which detects a synchronous state from the output of said demodulator to generate a control start flag;
a switch unit which determines a variation of a delay point on the basis of the comparison signal of said comparator, the demodulation state signal obtained in said state monitor, and the control start flag obtained in said synchronous state monitor when a point of switching between the gain control signal on the RF band and the gain control signal on the IF band in said tuner is set to be the delay point;
a delay point determination unit which renews a value of the delay point from the variation of the delay point outputted from said switch unit;
a timing controller which generates a timing control signal for reviewing a value of the optimum delay point per certain period;
an optimum delay point retainer which detects an optimum delay point within a certain time period from the value of the delay point of said delay point determination unit, the demodulation state signal of said state monitor, and the timing control signal of said timing controller and outputs a value of the optimum delay point;
a signal level detector which detects the signal level of the reception signal from the IF signal of said tuner; and
a control signal generator which generates the gain control signal on the RF band and the gain control signal on the IF band from the value of the optimum delay point retained in said optimum delay point retainer and the signal level of said signal level detector.

29. A digital broadcast receiver according to claim 28 wherein
said optimum delay point retainer stores and retains an optimum demodulation state within a time period of control in said timing controller and a value of the optimum delay point at that time.

30. A digital broadcast receiver according to claim 28 wherein
said optimum delay point retainer renews the value of the optimum delay point stored and retained per time period of control of said timing controller.

31. A digital broadcast receiver according to claim 28 wherein
said switch unit includes:
a control counter which is reset in response to the control start flag obtained in the synchronous state monitor and executes a counting every time when the variation of the delay point outputted from said switch unit is renewed, thereby counting up a control number;
a reception state judgment block which judges a reception state from the demodulation state signal, the value of the delay point, and the control number; and
a selection block which determines the variation of the delay point from the comparison result of the comparator and the judgment result of the reception state judgment block.

32. A digital broadcast receiver according to claim 31 wherein
said selection block selects and determines a specific variation of the delay point from a plurality of different delay point variations.

33. A digital broadcast receiver according to claim 32, wherein
the plurality of delay point variations selected in said selection block include at least one value significantly different from the other variations.
